(19) United States
(12) Patent Application Publication
(10) Pub. No.: US 2025/0314863 A1
(43) Pub. Date: Oct. 9, 2025

(54) OPTICAL IMAGING LENS ASSEMBLY

(71) Applicant: ZHEJIANG SUNNY OPTICS CO., LTD., Yuyao City (CN)

(72) Inventors: Yu QI, Yuyao City (CN); Wuchao XU, Yuyao City (CN); Fujian DAI, Yuyao City (CN)

(73) Assignee: ZHEJIANG SUNNY OPTICS CO., LTD., Yuyao City (CN)

(21) Appl. No.: 19/066,252

(22) Filed: Feb. 28, 2025

(30) Foreign Application Priority Data
Apr. 3, 2024 (CN) 202410400263.5

(51) Int. Cl. G02B 13/18; G02B 9/62

(52) U.S. Cl. CPC G02B 13/18; G02B 9/62

(57) ABSTRACT

The present application discloses an optical imaging lens assembly, comprising an optical lens group and a spacing element group, wherein the optical lens group comprises, in order from an object side to an image plane along an optical axis: a first lens group, comprising a first lens having a refractive power; a second lens group having a positive refractive power, comprising a second lens having a positive refractive power, a third lens having a negative refractive power, a fourth lens having a negative refractive power, a fifth lens having a refractive power and a sixth lens having a positive refractive power; and a third lens group, comprising a seventh lens having a negative refractive power; the spacing element group comprises a fourth spacing element being in contact with an image side surface of the fourth lens and a fifth spacing element being in contact with an image side surface of the fifth lens; an effective focal length F2 of the second lens group and a combined focal length f45 of the fourth lens and the fifth lens satisfy: −7.5≤f45/F2<−4.5; and a center thickness CT5 of the fifth lens on the optical axis, an air spacing T56 between the fifth lens and the sixth lens on the optical axis and a spacing EP45 between the fourth spacing element and the fifth spacing element along the optical axis satisfy: 1.0<(CT5+T56)/EP45<3.5.

### CROSS-REFERENCE TO RELATED APPLICATIONS

The present application claims the priority of Chinese patent application No. 202410400263.5, filed on Apr. 3, 2024, which is hereby incorporated by reference in its entirety.

### TECHNICAL FIELD

The present application relates to the field of optical devices, and specifically to an optical imaging lens assembly composed of three lens groups.

### BACKGROUND

In recent years, smart products have been rapidly updated and iterated and developing rapidly, wherein a lens assembly used for taking photos and videos is a component that is subject to key updates and iterations. Taking a smartphone as an example, a mobile phone is usually equipped with a front small lens assembly and a rear telephoto, wide-angle, and ultra-wide-angle lens assembly, thereby meeting the shooting needs of multiple scenes and multiple focal lengths. Switching and zooming of different lens assemblies in a smartphone are often achieved by means of digital zoom. However, the digital zoom process will cause image quality loss, thereby affecting the overall imaging effect.

### SUMMARY

The present application provides an optical imaging lens assembly that can at least or partially solve at least one problem existing in the prior art or other problems.

One aspect of the present application provides an optical imaging lens assembly, comprising a lens barrel subassembly, an optical lens group and a spacing element group, the lens barrel subassembly comprising a first lens barrel, a second lens barrel and a third lens barrel arranged in order from an object side to an image plane along an optical axis; wherein the optical lens group comprises, in order from the object side to the image plane along the optical axis: a first lens group disposed in the first lens barrel and comprising a first lens having a refractive power; a second lens group disposed in the second lens barrel and having a positive refractive power, comprising a second lens having a positive refractive power, a third lens having a negative refractive power, a fourth lens having a negative refractive power, a fifth lens having a refractive power and a sixth lens having a positive refractive power; and a third lens group disposed in the third lens barrel, comprising a seventh lens having a negative refractive power; positions of the first lens group and the third lens group relative to the image plane on the optical axis are fixed, and a distance of the second lens group relative to the first lens group on the optical axis is adjustable; the spacing element group comprises a fourth spacing element disposed on an image side surface of the fourth lens and being in contact with the image side surface of the fourth lens, and a fifth spacing element disposed on an image side surface of the fifth lens and being in contact with the image side surface of the fifth lens; an effective focal length F2 of the second lens group and a combined focal length f45 of the fourth lens and the fifth lens satisfy: −7.5≤f45/F2<−4.5; and a center thickness CT5 of the fifth lens on the optical axis, an air spacing T56 between the fifth lens and the sixth lens on the optical axis and a spacing EP45 between the fourth spacing element and the fifth spacing element along the optical axis satisfy: 1.0<(CT5+T56)/EP45<3.5.

According to an exemplary implementation of the present application, the spacing element group further comprises a third spacing element disposed on an image side surface of the third lens and being in contact with the image side surface of the third lens, wherein a center thickness CT4 of the fourth lens on the optical axis, an air spacing T45 between the fourth lens and the fifth lens on the optical axis, and a spacing EP34 between the third spacing element and the fourth spacing element along the optical axis satisfy:

$$0.5 < EP 34 / ( CT 4 + T 45 ) < 1.5 .$$

According to an exemplary implementation of the present application, an inner diameter d4s of an object side surface of the fourth spacing element, a center thickness CT4 of the fourth lens on the optical axis and a refractive index N4 of the fourth lens satisfy:

$$6. < d 4 s / ( N 4 \times CT 4 ) < 8.0 .$$

According to an exemplary implementation of the present application, an inner diameter d5s of an object side surface of the fifth spacing element, the center thickness CT5 of the fifth lens on the optical axis and a refractive index N5 of the fifth lens satisfy:

$$4. < d 5 s / ( N 5 \times CT 5 ) \leq 7.0 .$$

According to an exemplary implementation of the present application, the spacing element group further comprises a second spacing element disposed on an image side surface of the second lens and being in contact with the image side surface of the second lens, and a third spacing element disposed on an image side surface of the third lens and being in contact with the image side surface of the third lens, wherein the effective focal length F2 of the second lens group and a combined focal length f23 of the second lens and the third lens satisfy: 1.3≤f23/F2≤1.6, and a center thickness CT3 of the third lens on the optical axis, an air spacing T34 between the third lens and the fourth lens on the optical axis and a spacing EP23 between the second spacing element and the third spacing element along the optical axis satisfy: 0.3≤(T34−EP23)/CT3<1.5.

According to an exemplary implementation of the present application, the spacing element group further comprises a second spacing element disposed on an image side surface of the second lens and being in contact with the image side surface of the second lens, wherein an effective focal length f2 of the second lens, a refractive index N2 of the second lens, and a spacing EP022 between an object side end surface of the second lens barrel and the second spacing element along the optical axis satisfy: 3.5<(f2/N2)/EP022≤5.0.

According to an exemplary implementation of the present application, the spacing element group further comprises a second spacing element disposed on an image side surface of the second lens and being in contact with the image side surface of the second lens, wherein a center thickness CT2 of the second lens on the optical axis, an air spacing T23 between the second lens and the third lens on the optical axis, and a spacing EP022 between an object side end surface of the second lens barrel and the second spacing element along the optical axis satisfy: 1.0≤CT2/(EP022−T23)≤1.3.

According to an exemplary implementation of the present application, an effective focal length f6 of the sixth lens, an inner diameter d5s of an object side surface of the fifth spacing element, and an outer diameter D5m of an image side surface of the fifth spacing element satisfy: 2.0<f6/(D5m−d5s)<4.0.

According to an exemplary implementation of the present application, the combined focal length f45 of the fourth lens and the fifth lens, an inner diameter d4s of an object side surface of the fourth spacing element and an outer diameter D4m of an image side surface of the fourth spacing element satisfy: −27.5<f45/(D4m−d4s)<−11.

According to an exemplary implementation of the present application, an inner diameter d02m of an image side end surface of the second lens barrel and the effective focal length F2 of the second lens group satisfy: 1.5<d02m/F2≤1.8.

According to an exemplary implementation of the present application, an inner diameter d02s of an object side end surface of the second lens barrel, an outer diameter D02m of an image side end surface of the second lens barrel, and a length L2 of the second lens barrel along the direction of the optical axis satisfy: 1.5≤(D02m−d02s)/L2<1.7.

According to an exemplary implementation of the present application, an outer diameter D02m of an image side end surface of the second lens barrel, an inner diameter d03s of an object side end surface of the third lens barrel and a maximum movable distance ΔEP0 of the second lens barrel along the direction of the optical axis satisfy: 2.0<(d03s−D02m)/ΔEP0<3.5.

According to an exemplary implementation of the present application, a length L1 of the first lens barrel along the direction of the optical axis, a length L2 of the second lens barrel along the direction of the optical axis, a length L3 of the third lens barrel along the direction of the optical axis and a maximum movable distance ΔEP0 of the second lens barrel along the direction of the optical axis satisfy: 25<(L1+L2+L3)/ΔEP0≤31.

The optical imaging lens assembly provided by the present application comprises three lens groups, and the three lens groups are assembled in three lens barrels, respectively. The zoom of the optical imaging lens assembly can be achieved by moving the second lens group. In addition, by controlling the ratio of the combined focal length of the fourth lens and the fifth lens to the effective focal length of the second lens group, and controlling the relationship among the center thickness of the fifth lens on the optical axis, the air spacing between the fifth lens and the sixth lens on the optical axis, and the spacing between the fourth spacing element and the fifth spacing element along the optical axis, the space allocation and machinability/processability of the fifth lens and the sixth lens can be ensured while ensuring that the second lens group meets the space size.

### BRIEF DESCRIPTION OF THE DRAWINGS

Other features, objects, and advantages of the present application will become more apparent by reading a detailed description of non-restrictive embodiments made with reference to the following drawings, wherein

FIG. 1 shows a diagram of labeling parameters of an optical imaging lens assembly according to the present application;

FIG. 2 shows a schematic structural diagram of an optical lens group according to Embodiment 1, 2 or 3 of the present application;

FIG. 3 shows a schematic structural diagram of an optical imaging lens assembly according to Embodiment 1 of the present application;

FIG. 4 shows a schematic structural diagram of an optical imaging lens assembly according to Embodiment 2 of the present application;

FIG. 5 shows a schematic structural diagram of an optical imaging lens assembly according to Embodiment 3 of the present application;

FIGS. 6A to 6C show a longitudinal aberration curve, an astigmatism curve, and a distortion curve of the optical imaging lens assembly according to Embodiment 1, 2, or 3 of the present application in a telephoto state (for example, the distance between a captured object and the optical imaging lens assembly is infinite), respectively;

FIGS. 7A to 7C show a longitudinal aberration curve, an astigmatism curve, and a distortion curve of the optical imaging lens assembly according to Embodiment 1, 2, or 3 of the present application in a short focal length state (for example, the distance between a captured object and the optical imaging lens assembly is 150 mm), respectively;

FIG. 8 shows a schematic structural diagram of an optical lens group according to Embodiment 4, 5 or 6 of the present application;

FIG. 9 shows a schematic structural diagram of an optical imaging lens assembly according to Embodiment 4 of the present application;

FIG. 10 shows a schematic structural diagram of an optical imaging lens assembly according to Embodiment 5 of the present application;

FIG. 11 shows a schematic structural diagram of an optical imaging lens assembly according to Embodiment 6 of the present application;

FIGS. 12A to 12C show a longitudinal aberration curve, an astigmatism curve, and a distortion curve of the optical imaging lens assembly according to Embodiment 4, 5, or 6 of the present application in a telephoto state (for example, the distance between a captured object and the optical imaging lens assembly is infinite), respectively;

FIGS. 13A to 13C show a longitudinal aberration curve, an astigmatism curve, and a distortion curve of the optical imaging lens assembly according to Embodiment 4, 5, or 6 of the present application in a short focal length state (for example, the distance between a captured object and the optical imaging lens assembly is 150 mm), respectively;

FIG. 14 shows a schematic structural diagram of an optical lens group according to Embodiment 7, 8 or 9 of the present application;

FIG. 15 shows a schematic structural diagram of an optical imaging lens assembly according to Embodiment 7 of the present application;

FIG. 16 shows a schematic structural diagram of an optical imaging lens assembly according to Embodiment 8 of the present application;

FIG. 17 shows a schematic structural diagram of an optical imaging lens assembly according to Embodiment 9 of the present application;

FIGS. 18A to 18C show a longitudinal aberration curve, an astigmatism curve, and a distortion curve of the optical imaging lens assembly according to Embodiment 7, 8, or 9 of the present application in a telephoto state (for example, the distance between a captured object and the optical imaging lens assembly is infinite), respectively; and

FIGS. 19A to 19C show a longitudinal aberration curve, an astigmatism curve, and a distortion curve of the optical imaging lens assembly according to Embodiment 7, 8, or 9 of the present application in a short focal length state (for example, the distance between a captured object and the optical imaging lens assembly is 150 mm), respectively.

### DETAILED DESCRIPTION

In order to better understand the present application, various aspects of the present application will be described in more detail with reference to the drawings. It should be understood that the detailed description is merely description of exemplary implementations of the present application, and does not limit the scope of the present application in any way. Throughout the description, the same reference signs refer to the same elements.

It should be noted that in the present description, the expressions of “first”, “second”, “third” etc. are only used to distinguish one feature from another feature, and do not indicate any limitation on the feature. Therefore, without departing from the teachings of the present application, a first lens discussed below may also be referred to as a second lens or a third lens.

In the drawings, for convenience of explanation, the thickness, size, and shape of a lens have been slightly exaggerated. Specifically, the shapes of spherical or aspherical surfaces shown in the drawings are shown by way of example. That is, the shapes of the spherical or aspheric surfaces are not limited to those shown in the drawings. The drawings are only examples and are not drawn strictly to scale.

Herein, a paraxial region refers to a region near an optical axis. If a lens surface is convex and the position of the convex surface is not defined, then it means that the lens surface is convex at least in the paraxial region; and if a lens surface is concave and the position of the concave surface is not defined, then it means that the lens surface is concave at least in the paraxial region. A surface of each lens closest to a subject (=an object to be captured) is referred to as an object side surface of the lens, and a surface of each lens closest to an image plane is referred to as an image side surface of the lens.

It should also be understood that the terms “comprise” and/or “have” when used in this specification, just indicate the existence of stated features, elements and/or components, but do not exclude the presence or addition of one or more other features, elements, components and/or combinations thereof. In addition, when an implementation of the present application is described, “may” is used to indicate “one or more implementations of the present application”. Also, the term “exemplary” is intended to refer to an example or illustration.

Unless otherwise defined, all terms (including technical and scientific terms) used herein have the same meanings as commonly understood by those of ordinary skill in the art to which the present application belongs. It should also be understood that the terms (such as those defined in commonly used dictionaries) should be interpreted to have meanings consistent with their meanings in the context of the relevant art and will not be interpreted in an idealized or overly significance formal sense unless it is clearly defined herein.

It should be noted that, in the case of no conflict, the embodiments in the present application and the features in the embodiments may be combined with each other. The present application will be described in detail below in conjunction with embodiments with reference to the drawings.

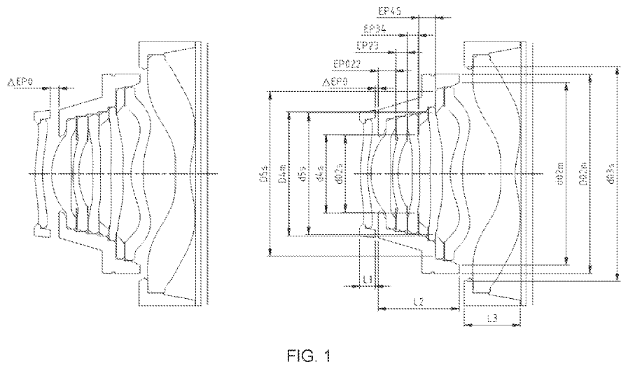

FIG. 1 is a diagram of labeling parameters of an optical imaging lens assembly according to an exemplary embodiment of the present application. With reference to FIG. 1, L1 represents the length of a first lens barrel along the direction of an optical axis, L2 represents the length of a second lens barrel along the direction of the optical axis, L3 represents the length of a third lens barrel along the direction of the optical axis, d02s represents the inner diameter of an object side end surface of the second lens barrel, d02m represents the inner diameter of an image side end surface of the second lens barrel, D02m represents the outer diameter of an image side end surface of the second lens barrel, d03s represents the inner diameter of an object side end surface of the third lens barrel, d4s represents the inner diameter of an object side surface of a fourth spacing element, D4m represents the outer diameter of an image side surface of the fourth spacing element, d5s represents the inner diameter of an object side surface of a fifth spacing element, D5m represents the outer diameter of an image side surface of the fifth spacing element, ΔEP0 represents a maximum movable distance of the second lens barrel along the direction of optical axis, EP022 represents the spacing between the object side end surface of the second lens barrel and a second spacing element along the optical axis, EP23 represents the spacing between the second spacing element and a third spacing element along the optical axis, EP34 represents the spacing between the third spacing element and the fourth spacing element along the optical axis, and EP45 represents the spacing between the fourth spacing element and the fifth spacing element along the optical axis.

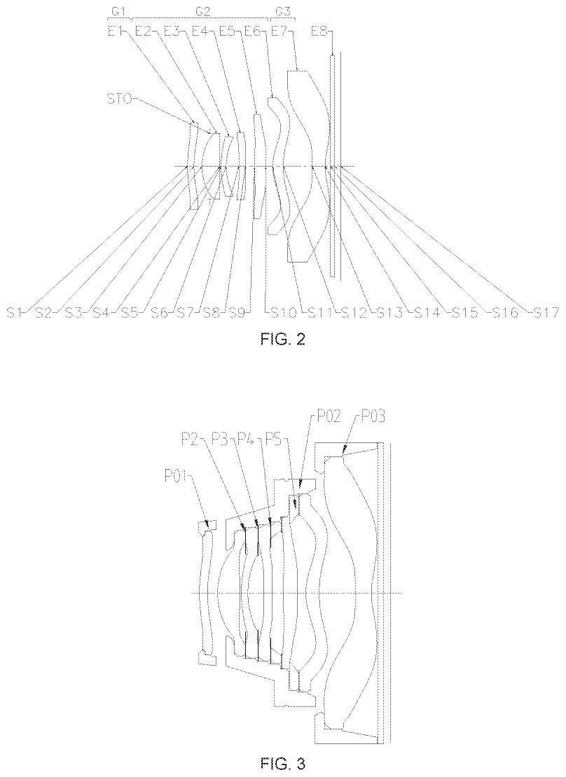

With reference to FIGS. 2 to 5, 8 to 11, and 14 to 17, a first aspect of the present application provides an optical imaging lens assembly, which may include an optical lens group. The optical lens group may include a first lens group, a second lens group, and a third lens group arranged in order from an object side to an image plane along the optical axis. In the first lens group to the third lens group, any two adjacent lens groups may have an air spacing therebetween.

The positions of the first lens group and the third lens group relative to the image plane on the optical axis are fixed. The second lens group is movable relative to the first lens group along the optical axis, that is, the distance of the second lens group relative to the first lens group on the optical axis is adjustable. When the distance between the captured object and the optical imaging lens assembly changes from far to near, the distance between the second lens group and the first lens group on the optical axis is adjusted, so that the optical imaging lens assembly can be switched between a telephoto state and a short focal length state, thereby achieving the zoom of the optical imaging lens assembly.

In an exemplary embodiment, the optical imaging lens assembly may further include a lens barrel subassembly, which may include a first lens barrel, a second lens barrel, and a third lens barrel arranged in order from the object side to the image plane along the optical axis. The first lens group may be disposed in the first lens barrel. The second lens group may be disposed in the second lens barrel. The third lens group may be disposed in the third lens barrel. Accordingly, the first lens barrel and the third lens barrel are fixed assemblies, and their positions relative to the image plane are fixed; the second lens barrel is a movable assembly, which can move with the movement of the second lens group during the zooming process of the optical imaging lens assembly.

In an exemplary implementation, the first lens group may include a first lens having a refractive power.

In an exemplary implementation, the second lens group may have a positive refractive power and include, in order from the object side to the image plane along the optical axis, a second lens having a positive refractive power, a third lens having a negative refractive power, a fourth lens having a negative refractive power, a fifth lens having a refractive power, and a sixth lens having a positive refractive power.

In an exemplary implementation, the third lens group may include a seventh lens having a negative refractive power.

In an exemplary implementation, the optical imaging lens assembly may further include one or more of a second spacing element, a third spacing element, a fourth spacing element, and a fifth spacing element. The second spacing element may be disposed on the image side surface of the second lens and is at least partially in contact with the image side surface of the second lens. The third spacing element may be disposed on the image side surface of the third lens and is at least partially in contact with the image side surface of the third lens. The fourth spacing element may be disposed on the image side surface of the fourth lens and is at least partially in contact with the image side surface of the fourth lens. The fifth spacing element may be disposed on the image side surface of the fifth lens and is at least partially in contact with the image side surface of the fifth lens. Reasonable use of spacing elements can effectively avoid the risk of stray light, reducing interference with image quality, and thereby improving the imaging quality of the optical imaging lens assembly. In an example, the second spacing element, the third spacing element, the fourth spacing element, and the fifth spacing element may be disposed in the second lens barrel.

In an exemplary implementation, the second lens group may further include a diaphragm disposed between the object side and the second lens.

In an exemplary embodiment, the effective focal length F2 of the second lens group and the combined focal length f45 of the fourth lens and the fifth lens may satisfy: −7.5≤f45/F2<−4.5. Reasonable configuration of the ratio of the effective focal length of the second lens group to the combined focal length of the fourth lens and the fifth lens is advantageous to balance the space size of the second lens group and constrain the axial length of the main lens group portion.

In an exemplary implementation, the center thickness CT5 of the fifth lens on the optical axis, the air spacing T56 between the fifth lens and the sixth lens on the optical axis, and the spacing EP45 between the fourth spacing element and the fifth spacing element along the optical axis satisfy: 1.0<(CT5+T56)/EP45<3.5. Reasonable control of the relationship among the center thickness of the fifth lens on the optical axis, the air spacing between the fifth lens and the sixth lens on the optical axis, and the spacing between the fourth spacing element and the fifth spacing element along the optical axis is advantageous to ensure the space allocation and machinability/processability of the fifth lens and the sixth lens while ensuring that the second lens group meets the space size.

The relationship between (CT5+T56)/EP45 and the yield rate of the optical imaging lens assembly will be further described in conjunction with Tables a, b and c.

Table a shows the yield rate of the optical imaging lens assembly when f45/F2=−4.96, and (CT5+T56)/EP45=1.20, that is, when the optical imaging lens assembly satisfies 1.0<(CT5+T56)/EP45<3.5. When the optical imaging lens assembly does not satisfy 1.0<(CT5+T56)/EP45<3.5, for example, Table b shows the yield rate of the optical imaging lens assembly when f45/F2=−4.79, and (CT5+T56)/EP45=4.1, and Table c shows the yield rate of the optical imaging lens assembly when f45/F2=−7.5, and (CT5+T56)/EP45=3.8.

It can be seen from Table b and Table c that the yield rate of the optical imaging lens assembly is lower, and it can be seen from Table a that the yield rate of the optical imaging lens assembly is higher. It follows that when the optical imaging lens assembly meets “−7.5≤f45/F2<−4.5”, the yield rate of the optical imaging lens assembly can be improved by adjusting the optical imaging lens assembly to meet “1.0<(CT5+T56)/EP45<3.5”.

TABLE a

| | Quantity of tests | Qualified quantity | Yield rate |
|---|---|---|---|
| First group | 618 | 219 | 35.44% |
| Second group | 685 | 231 | 33.72% |
| Third group | 711 | 275 | 38.68% |
| Fourth group | 631 | 208 | 32.96% |

TABLE b

| | Quantity of tests | Qualified quantity | Yield rate |
|---|---|---|---|
| First group | 468 | 128 | 27.35% |
| Second group | 669 | 169 | 25.26% |
| Third group | 683 | 173 | 25.33% |
| Fourth group | 581 | 144 | 24.78% |

TABLE c

| | Quantity of tests | Qualified quantity | Yield rate |
|---|---|---|---|
| First group | 518 | 131 | 25.29% |
| Second group | 598 | 147 | 24.58% |
| Third group | 530 | 105 | 19.81% |
| Fourth group | 477 | 119 | 24.95% |

In an exemplary implementation, the center thickness CT4 of the fourth lens on the optical axis, the air spacing T45 between the fourth lens and the fifth lens on the optical axis, and the spacing EP34 between the third spacing element and the fourth spacing element along the optical axis satisfy: 0.5<EP34/(CT4+T45)<1.5. Reasonable control of the relationship among the center thickness of the fourth lens on the optical axis, the air spacing between the fourth lens and the fifth lens on the optical axis, and the spacing between the third spacing element and the fourth spacing element along the optical axis is advantageous to constrain the ratio of the center thickness to the edge thickness of the fourth lens, improving the machinability/processability and assembling feasibility of the fourth lens, and avoiding the problem that the fourth lens cannot be machined and molded due to its too thin edge, or the assembling step difference is too large due to its too thick edge, thereby affecting the assembling process of the fourth lens.

In an exemplary implementation, the inner diameter d4s of the object side surface of the fourth spacing element, the center thickness CT4 of the fourth lens on the optical axis and the refractive index N4 of the fourth lens may satisfy: 6.0<d4s/(N4×CT4)<8.0. By reasonably configuring the ratio of the inner diameter of the object side surface of the fourth spacing element to the product of the center thickness and the refractive index of the fourth lens, when light passes through the fourth lens by a certain optical path, the clear aperture of the fourth lens can be constrained within a certain range, avoiding the problem of dark corners caused by too small clear aperture of the fourth lens or significant stray light caused by too large clear aperture, and improving the imaging effect of the optical imaging lens assembly.

In an exemplary implementation, the inner diameter d5s of the object side surface of the fifth spacing element, the center thickness CT5 of the fifth lens on the optical axis and the refractive index N5 of the fifth lens may satisfy: 4.0<d5s/(N5×CT5)≤7.0. By reasonably configuring the ratio of the inner diameter of the object side surface of the fifth spacing element to the product of the center thickness and the refractive index of the fifth lens, when light passes through the fifth lens by a certain optical path, the clear aperture of the fifth lens can be constrained within a certain range, avoiding the problem of dark corners caused by too small clear aperture of the fifth lens or significant stray light caused by too large clear aperture, and improving the imaging effect of the optical imaging lens assembly.

In an exemplary implementation, the effective focal length F2 of second lens group and a combined focal length f23 of the second lens and the third lens may satisfy: 1.3≤f23/F2≤1.6. Reasonable configuration of the ratio of the combined focal length of the second lens and the third lens to the effective focal length of the second lens group is advantageous to control the degree of convergence of light by the second lens and the third lens, thereby constraining the field-of-view angle and the total effective focal length of the optical imaging lens assembly within a reasonable range, so as to be more suitable for the second lens group to perform zooming by movement.

In an exemplary implementation, the center thickness CT3 of the third lens on the optical axis, the air spacing T34 between the third lens and the fourth lens on the optical axis and the spacing EP23 between the second spacing element and the third spacing element along optical axis satisfy: 0.3≤(T34−EP23)/CT3<1.5. Reasonable control of the relationship among the center thickness of the third lens on the optical axis, the air spacing between the third lens and the fourth lens on the optical axis, and the spacing between the second spacing element and the third spacing element along the optical axis is advantageous to allocate the air spacing before and after the third lens and the thickness of the spacing elements, thereby improving the machinability/processability and assembly stability of the third lens.

In an exemplary implementation, the effective focal length f2 of the second lens, the refractive index N2 of the second lens, and the spacing EP022 between the object side end surface of the second lens barrel and the second spacing element along the optical axis may satisfy: 3.5<(f2/N2)/EP022≤5.0. By reasonably controlling the relationship among the effective focal length of the second lens, the refractive index of the second lens, and the spacing between the object side end surface of the second lens barrel and the second spacing element along the optical axis, the effective focal length and edge thickness of the second lens, and the supporting thickness of the second lens barrel can be constrained within a certain range, avoiding the problem of being unable to be machined and molded due to the thin edge of the second lens, while ensuring the plastic material filling of the object side end surface of the second lens barrel, and improving the molding feasibility of the second lens barrel and the second lens.

In an exemplary implementation, the center thickness CT2 of the second lens on the optical axis, the air spacing T23 between the second lens and the third lens on the optical axis, and the spacing EP022 between the object side end surface of the second lens barrel and the second spacing element along the optical axis may satisfy: 1.0≤CT2/(EP022−T23)≤1.3. By reasonably controlling the relationship among the center thickness of the second lens on the optical axis, the air spacing between the second lens and the third lens on the optical axis, and the spacing between the object side end surface of the second lens barrel and the second spacing element along the optical axis, the center thickness of the second lens can be constrained within a machinable/processable range; at the same time, the air spacing between the second lens and the third lens on the optical axis, and the spacing between the object side end surface of the second lens barrel and the second spacing element along the optical axis can also be limited, which well guarantees the connection between the second lens and the third lens, and ensures the stability of the air spacing between the second lens and the third lens when they are assembling, thereby improving the imaging field curvature stability and imaging quality of the optical imaging lens assembly.

In an exemplary implementation, the effective focal length f6 of the sixth lens, the inner diameter d5s of the object side surface of the fifth spacing element, and the outer diameter D5m of the image side surface of the fifth spacing element may satisfy: 2.0<f6/(D5m−d5s)<4.0. Reasonable configuration of the ratio of the effective focal length of the sixth lens to the difference between the outer diameter of the image side surface and the inner diameter of the object side surface of the fifth spacing element is advantageous to limit the emission angle and emission range of light emitted from the second lens group, so that the second lens group is better matched with the third lens group during the zooming process of the optical imaging lens assembly; at the same time, it is also advantageous to make the bandwidth of the fifth spacing element wider, ensuring that the fifth spacing element plays a better light blocking role while ensuring the machinability/processability of the fifth spacing element, and avoiding the influence of the overall illumination of the optical imaging lens assembly due to the excessive bandwidth of the fifth spacing element.

In an exemplary implementation, the combined focal length f45 of the fourth lens and the fifth lens, the inner diameter d4s of the object side surface of the fourth spacing element and the outer diameter D4m of the image side surface of the fourth spacing element may satisfy: −27.5<f45/(D4m−d4s)<−11. By reasonably configuring the ratio of the combined focal length of the fourth lens and the fifth lens to the difference between the outer diameter of the image side surface and the inner diameter of the object side surface of the fourth spacing element, the combined focal length of the fourth lens and the fifth lens can be caused to be a negative value, ensuring better transition of light in the outer field of view; at the same time, the difference between the outer diameter of the image side surface and the inner diameter of the object side surface of the fourth spacing element can be constrained within a certain range, avoiding a large step difference between the fourth lens and the fifth lens, so that the fourth lens and the fifth lens are more stable when assembling.

In an exemplary implementation, the inner diameter d02m of the image side end surface of the second lens barrel and the effective focal length F2 of the second lens group may satisfy: 1.5<d02m/F2≤1.8. By reasonably configuring the ratio of the inner diameter of the image side end surface of the second lens barrel to the effective focal length of the second lens group, in the case that the effective focal length of the second lens group is constant, the second lens barrel can be made as small as possible without interfering with the effective light, thereby ensuring that the imaging quality of the second lens group can be improved while the second lens group is miniaturized; the second lens group can also have an appropriate effective focal length, thereby improving the zoom feasibility of the second lens group.

In an exemplary implementation, the inner diameter d02s of the object side end surface of the second lens barrel, the outer diameter D02m of the image side end surface of the second lens barrel, and the length L2 of the second lens barrel along the direction of the optical axis may satisfy: 1.5≤(D02m−d02s)/L2≤1.7. By reasonably configuring the ratio of the difference between the outer diameter of the image side end surface and the inner diameter of the object side end surface of the second lens barrel to the length of the second lens barrel along the direction of the optical axis, the axial size and vertical-axis size of the second lens group can be constrained within an appropriate range, and it can be ensured that the step difference between the object side end size and the image side end size of the second lens group is appropriate, so that the second lens barrel can better fit the second lens group; at the same time, in the case that the vertical-axis space of the second lens group is constant, the axial length of the optical imaging lens assembly can be better compressed to ensure that the optical imaging lens assembly is miniaturized.

In an exemplary implementation, the outer diameter D02m of the image side end surface of the second lens barrel, the inner diameter d03s of the object side end surface of the third lens barrel and the maximum movable distance ΔEP0 of the second lens barrel along the direction of the optical axis may satisfy: 2.0<(d03s-D02m)/ΔEP0<3.5. By reasonably configuring the ratio of the difference between the inner diameter of the object side end surface of the third lens barrel and the outer diameter of the image side end surface of the second lens barrel to the maximum movable distance of the second lens barrel along the direction of the optical axis, the step difference between the object side end surface of the third lens barrel and the image side end surface of the second lens barrel can be constrained within a certain range, so that the second lens group can be better matched with the seventh lens; at the same time, the axial zoom distance of the second lens group can also be effectively regulated to prevent the second lens group from colliding with the first lens group or the third lens group during the zooming process of the optical imaging lens assembly, ensuring that the optical imaging lens assembly has good imaging resolution.

In an exemplary implementation, the length L1 of the first lens barrel along the direction of the optical axis, the length L2 of the second lens barrel along the direction of the optical axis, the length L3 of the third lens barrel along the direction of the optical axis and the maximum movable distance ΔEP0 of the second lens barrel along the direction of the optical axis may satisfy: 25<(L1+L2+L3)/ΔEP0≤31. Reasonable configuration of the ratio of the sum of the lengths of the first lens barrel, the second lens barrel, and the third lens barrel along the direction of the optical axis to the maximum movable distance of the second lens barrel along the direction of the optical axis is advantageous to regulate the zoom range of the second lens group, and it is ensured that the second lens barrel does not collide with the first lens barrel or the third lens barrel, while allowing the second lens group to have a sufficient zoom range.

According to the above-mentioned implementations of the present application, the optical imaging lens assembly may be provided with seven lenses, three lens barrels, and at least one spacing element. By reasonably allocating the parameters of each lens, each lens barrel, and each spacing element, the zoom feasibility of the second lens group can be ensured, and the second lens group can be prevented from colliding with the first lens group and the third lens group during the zooming process of the optical imaging lens assembly, and the machinability/processability, assembling stability, and imaging quality of the optical imaging lens assembly can also be improved.

In the implementations of the present application, at least one of the surfaces of the respective lenses among the first lens to the seventh lens is an aspherical surface. The characteristic of an aspherical lens is that the curvature changes continuously from the center of the lens to the periphery of the lens. Unlike a spherical lens having a constant curvature from the center of the lens to the periphery of the lens, the aspherical lens has a better curvature radius characteristic, and has the advantages of improving distortion aberration and improving astigmatism aberration. Since the aspherical lens is adopted, the aberrations that occur during imaging can be eliminated as much as possible, thereby improving the imaging quality. Optionally, both the object side surface and the image side surface of each lens of the first lens to the seventh lens are aspherical surfaces.

A second aspect of the present application provides an optical imaging lens assembly, which includes a barrel subassembly, an optical lens group and a spacing element group. The barrel subassembly includes a first barrel, a second barrel and a third barrel arranged in order from the object side to the image plane along the optical axis. The optical lens group includes, in order from the object side to the image plane along the optical axis: a first lens group disposed in the first barrel, including a first lens having a refractive power; a second lens group disposed in the second barrel and having a positive refractive power, including a second lens having a positive refractive power, a third lens having a negative refractive power, a fourth lens having a negative refractive power, a fifth lens having a refractive power and a sixth lens having a positive refractive power; and a third lens group disposed in the third barrel, including a seventh lens having a negative refractive power. The positions of the first lens group and the third lens group relative to the image plane on the optical axis are fixed, and the distance of the second lens group relative to the first lens group on the optical axis is adjustable. The spacing element group includes a fourth spacing element disposed on an image side surface of the fourth lens and being in contact with the image side surface of the fourth lens, and a fifth spacing element disposed on an image side surface of the fifth lens and being in contact with the image side surface of the fifth lens.

The outer diameter D02m of the image side end surface of the second lens barrel, the inner diameter d03s of the object side end surface of the third lens barrel and the maximum movable distance ΔEP0 of the second lens barrel along the direction of the optical axis may satisfy: 2.0<(d03s−D02m)/ΔEP0<3.5. The optical imaging lens assembly provided by the present application includes three lens groups, and the three lens groups are assembled in three lens barrels, respectively. The zoom of the optical imaging lens assembly can be achieved by moving the second lens group. By reasonably configuring the ratio of the difference between the inner diameter of the object side end surface of the third lens barrel and the outer diameter of the image side end surface of the second lens barrel to the maximum movable distance of the second lens barrel along the direction of the optical axis, the step difference between the object side end surface of the third lens barrel and the image side end surface of the second lens barrel can be constrained within a certain range, so that the second lens group can be better matched with the seventh lens; at the same time, the axial zoom distance of the second lens group can also be effectively regulated, to prevent the second lens group from colliding with the first lens group or the third lens group during the zooming process of the optical imaging lens assembly, ensuring that the optical imaging lens assembly has good imaging resolution.

It should be understood by those skilled in the art that the number of lenses and spacing elements constituting the optical imaging lens assembly can be changed without departing from the technical solutions claimed in the present application, to obtain respective results and advantages described in the specification.

Specific embodiments of the optical imaging lens assembly applicable to the above-mentioned implementations will be further described below with reference to the drawings.

### Embodiment 1

An optical imaging lens assembly according to Embodiment 1 of the present application will be described below with reference to FIGS. 2 and 3.

As shown in FIGS. 2 and 3, the optical imaging lens assembly includes a lens barrel subassembly, an optical lens group and a spacing element group. The lens barrel subassembly includes a first lens barrel P01, a second lens barrel P02 and a third lens barrel P03 arranged in order from an object side to an image plane along an optical axis.

The optical lens group includes, in order from the object side to the image plane along the optical axis: a first lens group G1 disposed in the first lens barrel P01, a second lens group G2 disposed in the second lens barrel P02 and having a positive refractive power, and a third lens group G3 disposed in the third lens barrel P03 and having a negative refractive power. The positions of the first lens group G1 and the third lens group G3 relative to the image plane on the optical axis are fixed. The second lens group G2 is movable relative to the first lens group G1 along the optical axis. When the distance between a captured object and the optical imaging lens assembly changes from far to near, the distance between the second lens group G2 and the first lens group G1 on the optical axis is adjusted, so that the optical imaging lens assembly can be switched between a telephoto state and a short focal length state, thereby achieving the zoom of the optical imaging lens assembly. In an example, the first lens group G1 includes a first lens E1. The second lens group G2 includes a second lens E2, a third lens E3, a fourth lens E4, a fifth lens E5, and a sixth lens E6 in order from the object side to the image plane along the optical axis. The third lens group G3 includes a seventh lens E7. The second lens group G2 further includes a diaphragm STO, which is disposed between the object side and the second lens E2.

The first lens E1 has a negative refractive power, and has a convex object side surface S1 and a concave image side surface S2. The second lens E2 has a positive refractive power, and has a convex object side surface S3 and a convex image side surface S4. The third lens E3 has a negative refractive power, and has a convex object side surface S5 and a concave image side surface S6. The fourth lens E4 has a negative refractive power, and has a convex object side surface S7 and a concave image side surface S8. The fifth lens E5 has a negative refractive power, and has a convex object side surface S9 and a concave image side surface S10. The sixth lens E6 has a positive refractive power, and has a convex object side surface S11 and a concave image side surface S12. The seventh lens E7 has a negative refractive power, and has a convex object side surface S13 and a concave image side surface S14. A filter E8 is further provided between the seventh lens E7 and the image plane S17, and the filter E8 has an object side surface S15 and an image side surface S16. Light from the object sequentially passes through the surfaces S1 to S16 and is finally imaged on the image plane S17.

The spacing element group includes a second spacing element P2, a third spacing element P3, a fourth spacing element P4 and a fifth spacing element P5 disposed in the second lens barrel P02. Each of the spacing elements can block excess light in an imaging process from entering the next lens, while making the respective lenses and the second lens barrel P02 better supported, thereby enhancing the structural stability of the optical imaging lens assembly.

Table 1 shows a table of basic parameters of the optical imaging lens assembly of Embodiment 1, wherein the units of the radius of curvature, thickness/distance, and focal length are all millimeters (mm).

TABLE 1

| Surface | Surface | Radius of | | | | Focal | Cone |
|---|---|---|---|---|---|---|---|
| No. | type | curvature | Thickness | Material | | length | coefficient |
| OBJ | Spherical | Infinite | U | | | | |
| S1 | Aspherical | 8.3790 | 0.4754 | 1.64 | 23.5 | −92.64 | 0.0691 |
| S2 | Aspherical | 7.1839 | D1 | | | | −0.0158 |
| STO | Spherical | Infinite | −0.5687 | | | | 0.0000 |
| S3 | Aspherical | 4.0920 | 1.2961 | 1.55 | 55.9 | 7.02 | −0.0041 |
| S4 | Aspherical | −53.3619 | 0.0983 | | | | −47.1157 |
| S5 | Aspherical | 6.2881 | 0.3800 | 1.68 | 19.2 | −19.63 | 0.0286 |
| S6 | Aspherical | 4.1639 | 0.9297 | | | | 0.0153 |
| S7 | Aspherical | 53.9583 | 0.4900 | 1.64 | 23.5 | −68.42 | 99.0000 |
| S8 | Aspherical | 24.1690 | 0.6654 | | | | 4.3559 |
| S9 | Aspherical | 17.3807 | 0.8046 | 1.55 | 55.9 | −73.35 | −0.0822 |
| S10 | Aspherical | 11.9204 | 0.5188 | | | | −0.3932 |
| S11 | Aspherical | 3.2332 | 0.7861 | 1.55 | 55.9 | 10.13 | −1.0173 |
| S12 | Aspherical | 7.1177 | D2 | | | | 0.0579 |
| S13 | Aspherical | 87.5066 | 0.9456 | 1.55 | 55.9 | −7.68 | 92.7060 |
| S14 | Aspherical | 3.9843 | 0.3815 | | | | −1.0428 |
| S15 | Spherical | Infinite | 0.3238 | 1.52 | 64.2 | | |
| S16 | Spherical | Infinite | 0.4397 | | | | |
| S17 | Spherical | Infinite | | | | | |

In this embodiment, both the object side surface and image side surface of any one of the first lens E1 to the seventh lens E7 are aspherical, and the surface profile x of each aspherical lens can be defined by using but not limited to the following aspherical formula:

$$x = \frac{{ch}^{2}}{1 + \sqrt{1 - ( k + 1 ) {c}^{2} {h}^{2}}} + \sum {Aih}^{\text{?}} \qquad ( 1 )$$

$$\text{?} \text{indicates text missing or illegible when filed}$$

where x is a distance vector height from a vertex of the aspherical surface when the aspherical surface is positioned at a height of h along the direction of the optical axis; c is paraxial curvature of the aspherical surface, c=1/R (that is, the paraxial curvature c is the reciprocal of the radius of curvature R in Table 1 above); k is a conic coefficient; and Ai is a correction coefficient of an i-th order of the aspherical surface. Table 2 shows high-order coefficients A₄, A₆, A₈, A₁₀, A₁₂, A₁₄, A₁₆, A₁₈, A₂₀, A₂₂, A₂₄, A₂₆, A₂₈ and A₃₀ of each of the aspherical surfaces S1 to S14 that are applicable in Embodiment 1.

TABLE 2

| Surface No. | A4 | A6 | A8 | A10 | A12 | A14 | A16 |
|---|---|---|---|---|---|---|---|
| S1 | −4.3319E−03 | −1.9088E−04 | 6.8345E−05 | −1.3657E−05 | 1.9734E−06 | −1.7814E−07 | 8.7244E−09 |
| S2 | −4.2176E−03 | −4.1688E−04 | 1.6687E−04 | −4.1040E−05 | 6.8678E−06 | −7.0866E−07 | 3.9982E−08 |
| S3 | 1.4678E−03 | −5.2892E−04 | 4.3603E−04 | −2.2941E−04 | 8.0752E−05 | −1.8400E−05 | 2.6527E−06 |
| S4 | −3.8724E−03 | 7.2404E−03 | 5.6443E−03 | 2.9219E−03 | −1.0182E−03 | 2.3444E−04 | −3.3959E−05 |
| S5 | −1.4032E−02 | 9.8207E−03 | −6.2320E−03 | 3.0136E−03 | −1.0277E−03 | 2.3712E−04 | −3.5019E−05 |
| S6 | −1.1513E−02 | 5.0946E−03 | −2.4565E−03 | 1.3043E−03 | −5.8904E−04 | 1.9425E−04 | −4.1265E−05 |
| S7 | −1.0478E−02 | 9.0836E−04 | −5.4124E−04 | 1.9335E−04 | −3.5731E−05 | 3.6399E−06 | −3.2985E−07 |
| S8 | −1.1453E−02 | 1.6472E−03 | 2.1273E−04 | −1.3512E−03 | 1.2892E−03 | −6.9689E−04 | 2.4530E−04 |
| S9 | −1.3858E−02 | 5.6990E−03 | −1.9466E−03 | 4.8903E−04 | −9.0828E−05 | 1.2026E−05 | −1.0703E−06 |
| S10 | −3.4649E−02 | 1.0445E−02 | −2.6004E−03 | 4.6882E−04 | −4.7033E−05 | −8.2344E−07 | 1.0242E−06 |
| S11 | −1.7626E−02 | 3.1493E−03 | −6.5621E−04 | 9.9856E−05 | −1.2467E−05 | 1.3113E−06 | −1.1320E−07 |
| S12 | 4.5865E−03 | −1.9232E−03 | 3.4215E−04 | −5.5444E−05 | 6.5729E−06 | −5.0155E−07 | 1.9930E−08 |
| S13 | −2.2789E−02 | 2.9528E−03 | −3.1429E−04 | 2.8890E−05 | −1.9333E−06 | 8.4048E−08 | −1.9558E−09 |
| S14 | −2.3691E−02 | 3.6738E−03 | −5.0233E−04 | 5.3894E−05 | −4.3658E−06 | 2.6314E−07 | −1.1782E−08 |
| Surface No. | A18 | A20 | A22 | A24 | A26 | A28 | A30 |
| S1 | −1.7572E−10 | 0.0000E+00 | 0.0000E+00 | 0.0000E+00 | 0.0000E+00 | 0.0000E+00 | 0.0000E+00 |
| S2 | −9.3799E−10 | 0.0000E+00 | 0.0000E+00 | 0.0000E+00 | 0.0000E+00 | 0.0000E+00 | 0.0000E+00 |
| S3 | −2.2227E−07 | 8.4972E−09 | 0.0000E+00 | 0.0000E+00 | 0.0000E+00 | 0.0000E+00 | 0.0000E+00 |
| S4 | 2.7936E−06 | −9.8924E−08 | 0.0000E+00 | 0.0000E+00 | 0.0000E+00 | 0.0000E+00 | 0.0000E+00 |
| S5 | 2.9868E−06 | −1.1215E−07 | 0.0000E+00 | 0.0000E+00 | 0.0000E+00 | 0.0000E+00 | 0.0000E+00 |
| S6 | 4.9757E−06 | −2.5662E−07 | 0.0000E+00 | 0.0000E+00 | 0.0000E+00 | 0.0000E+00 | 0.0000E+00 |
| S7 | 7.3776E−08 | −6.3444E−09 | 0.0000E+00 | 0.0000E+00 | 0.0000E+00 | 0.0000E+00 | 0.0000E+00 |
| S8 | −5.8083E−05 | 9.1993E−06 | −9.3579E−07 | 5.5345E−08 | −1.4482E−09 | 0.0000E+00 | 0.0000E+00 |
| S9 | 6.1369E−08 | −2.3858E−09 | 8.7548E−11 | −3.4633E−12 | 7.3236E−14 | 0.0000E+00 | 0.0000E+00 |
| S10 | −1.5502E−07 | 1.2313E−08 | −5.6493E−10 | 1.4158E−11 | −1.5046E−13 | 0.0000E+00 | 0.0000E+00 |
| S11 | 7.5657E−09 | −3.6417E−10 | 1.1635E−11 | −2.1828E−13 | 1.8060E−15 | 0.0000E+00 | 0.0000E+00 |
| S12 | 1.7682E−10 | −7.0881E−11 | 4.1920E−12 | −1.2854E−13 | 2.1149E−15 | −1.4801E−17 | 0.0000E+00 |
| S13 | −5.6587E−12 | 2.1381E−12 | −7.9418E−14 | 1.6118E−15 | −1.9757E−17 | 1.3802E−19 | −4.2499E−22 |
| S14 | 3.9246E−10 | −9.6970E−12 | 1.7554E−13 | −2.2646E−15 | 1.9730E−17 | −1.0406E−19 | 2.5093E−22 |

In this embodiment, the total effective focal length f of the optical imaging lens assembly is 8.60 mm.

Table 3 shows the distance U between the captured object and the optical imaging lens assembly, the air spacing D1 between the first lens group and the second lens group on the optical axis, and the air spacing D2 between the second lens group and the third lens group on the optical axis according to Embodiment 1, wherein the units of U, D1, and D2 are all millimeters (mm). When U is infinite, the optical imaging lens assembly is in a telephoto state; when U is 150 mm, the optical imaging lens assembly is in a short focal length state.

TABLE 3

| | | |
|---|---|---|
| Object distance U | Infinity | 150 |
| D1 | 1.1643 | 0.7803 |
| D2 | 2.1192 | 2.5032 |

### Embodiment 2

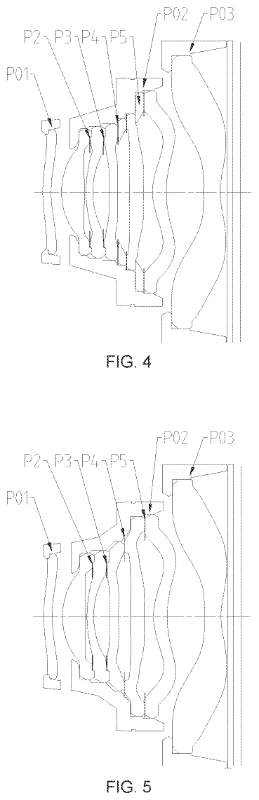

An optical imaging lens assembly according to Embodiment 2 of the present application will be described below with reference to FIGS. 2 and 4.

As shown in FIGS. 2 and 4, the optical imaging lens assembly includes a lens barrel subassembly, an optical lens group and a spacing element group. The lens barrel subassembly includes a first lens barrel P01, a second lens barrel P02 and a third lens barrel P03 arranged in order from an object side to an image plane along an optical axis. The structure of the optical lens group is the same as that of the optical lens group of Embodiment 1. The spacing element group includes a second spacing element P2, a third spacing element P3, a fourth spacing element P4 and a fifth spacing element P5 disposed in the second lens barrel P02.

The structure of the optical lens group of this embodiment is the same as that of the optical lens group of Embodiment 1, that is, the basic parameter table of the optical imaging lens assembly of this embodiment is the same as Table 1, and the aspheric coefficient table is the same as Table 2. The difference between this embodiment and Embodiment 1 is that the structural dimensions of the first lens barrel P01, the second lens barrel P02, the third lens barrel P03, the second spacing element P2, the third spacing element P3, the fourth spacing element P4 and the fifth spacing element P5 are different. For example, parameters such as L1, L2, L3, d02s, d02m, D02m, d03s, d4s, D4m, d5s, D5m, ΔEP0, EP022, EP23, EP34 and EP45 are different.

### Embodiment 3

An optical imaging lens assembly according to Embodiment 3 of the present application will be described below with reference to FIGS. 2 and 5.

As shown in FIGS. 2 and 5, the optical imaging lens assembly includes a lens barrel subassembly, an optical lens group and a spacing element group. The lens barrel subassembly includes a first lens barrel P01, a second lens barrel P02 and a third lens barrel P03 arranged in order from an object side to an image plane along an optical axis. The structure of the optical lens group is the same as that of the optical lens group of Embodiment 1. The spacing element group includes a second spacing element P2, a third spacing element P3, a fourth spacing element P4 and a fifth spacing element P5 disposed in the second lens barrel P02.

The structure of the optical lens group of this embodiment is the same as that of the optical lens group of Embodiment 1, that is, the basic parameter table of the optical imaging lens assembly of this embodiment is the same as Table 1, and the aspheric coefficient table is the same as Table 2. The difference between this embodiment and Embodiment 1 is that the structural dimensions of the first lens barrel P01, the second lens barrel P02, the third lens barrel P03, the second spacing element P2, the third spacing element P3, the fourth spacing element P4 and the fifth spacing element P5 are different. For example, parameters such as L1, L2, L3, d02s, d02m, D02m, d03s, d4s, D4m, d5s, D5m, ΔEP0, EP022, EP23, EP34 and EP45 are different.

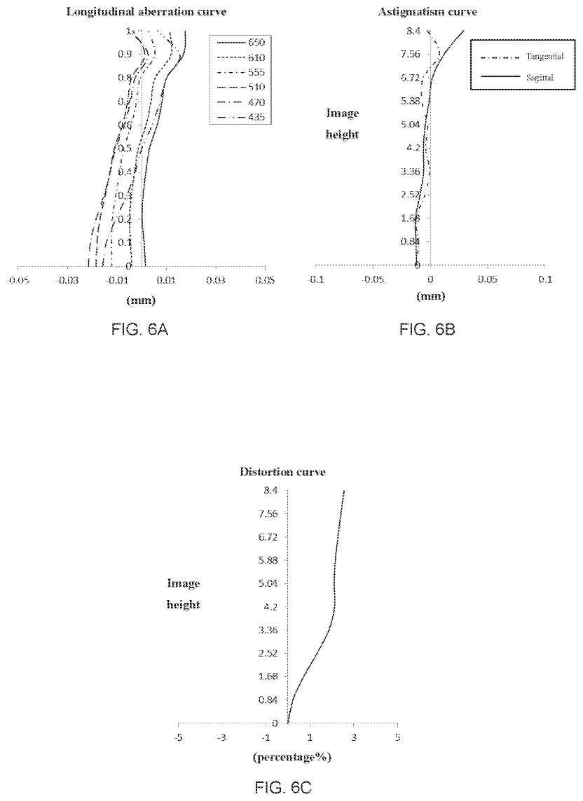

FIG. 6A shows a longitudinal aberration curve of the optical imaging lens assembly of Embodiment 1, 2 or 3 in the telephoto state, which indicates the deviation of the converged focal point of light of the respective different wavelengths after passing through the optical imaging lens assembly. FIG. 6B shows an astigmatism curve of the optical imaging lens assembly of Embodiment 1, 2 or 3 in the telephoto state, which indicates the curvature of the tangential image plane and the curvature of the sagittal image plane corresponding to different image heights. FIG. 6C shows a distortion curve of the optical imaging lens assembly of Embodiment 1, 2 or 3 in the telephoto state, which indicates distortion magnitude values corresponding to different image heights. It can be seen from FIGS. 6A to 6C that the optical imaging lens assembly of Embodiment 1, 2 or 3 can achieve good imaging quality in the telephoto state.

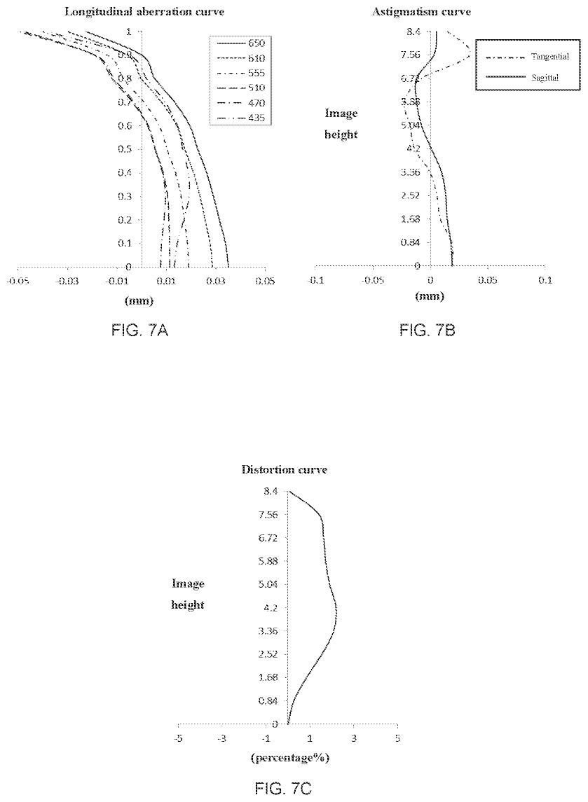

FIG. 7A shows a longitudinal aberration curve of the optical imaging lens assembly of Embodiment 1, 2 or 3 in the short focal length state, which indicates the deviation of the converged focal point of light of the respective different wavelengths after passing through the optical imaging lens assembly. FIG. 7B shows an astigmatism curve of the optical imaging lens assembly of Embodiment 1, 2 or 3 in the short focal length state, which indicates the curvature of the tangential image plane and the curvature of the sagittal image plane corresponding to different image heights. FIG. 7C shows a distortion curve of the optical imaging lens assembly of Embodiment 1, 2 or 3 in the short focal length state, which indicates distortion magnitude values corresponding to different image heights. It can be seen from FIGS. 7A to 7C that the optical imaging lens assembly of Embodiment 1, 2 or 3 can achieve good imaging quality in the short focal length state.

### Embodiment 4

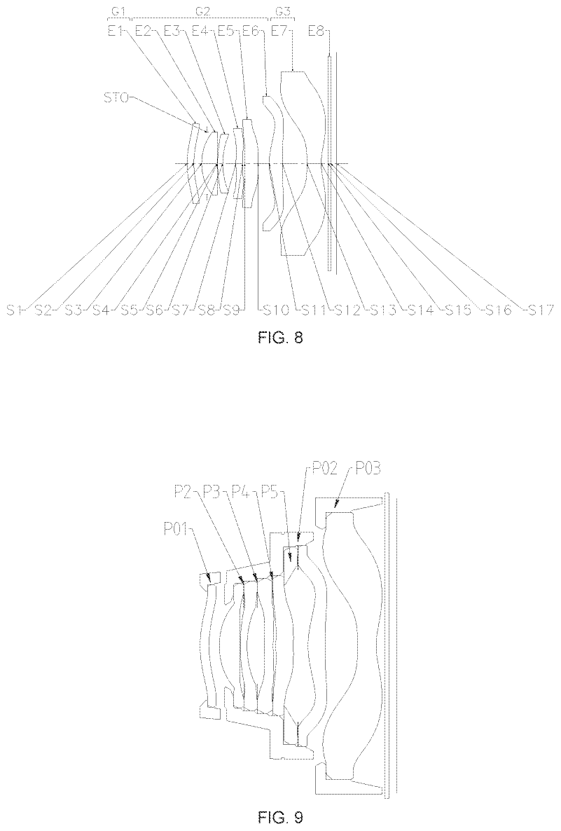

An optical imaging lens assembly according to Embodiment 4 of the present application will be described below with reference to FIGS. 8 and 9.

As shown in FIGS. 8 and 9, the optical imaging lens assembly includes a lens barrel subassembly, an optical lens group and a spacing element group. The lens barrel subassembly includes a first lens barrel P01, a second lens barrel P02 and a third lens barrel P03 arranged in order from an object side to an image plane along an optical axis.

The optical lens group includes, in order from the object side to the image plane along the optical axis: a first lens group G1 disposed in the first lens barrel P01, a second lens group G2 disposed in the second lens barrel P02 and having a positive refractive power, and a third lens group G3 disposed in the third lens barrel P03 and having a negative refractive power. The positions of the first lens group G1 and the third lens group G3 relative to the image plane on the optical axis are fixed. The second lens group G2 is movable relative to the first lens group G1 along the optical axis. When the distance between a captured object and the optical imaging lens assembly changes from far to near, the distance between the second lens group G2 and the first lens group G1 on the optical axis is adjusted, so that the optical imaging lens assembly can be switched between a telephoto state and a short focal length state, thereby achieving the zoom of the optical imaging lens assembly. In an example, the first lens group G1 includes a first lens E1. The second lens group G2 includes a second lens E2, a third lens E3, a fourth lens E4, a fifth lens E5, and a sixth lens E6 in order from the object side to the image plane along the optical axis. The third lens group G3 includes a seventh lens E7. The second lens group G2 further includes a diaphragm STO, which is disposed between the object side and the second lens E2.

The first lens E1 has a positive refractive power, and has a convex object side surface S1 and a concave image side surface S2. The second lens E2 has a positive refractive power, and has a convex object side surface S3 and a concave image side surface S4. The third lens E3 has a negative refractive power, and has a convex object side surface S5 and a concave image side surface S6. The fourth lens E4 has a negative refractive power, and has a convex object side surface S7 and a concave image side surface S8. The fifth lens E5 has a positive refractive power, and has a convex object side surface S9 and a concave image side surface S10. The sixth lens E6 has a positive refractive power, and has a convex object side surface S11 and a concave image side surface S12. The seventh lens E7 has a negative refractive power, and has a concave object side surface S13 and a concave image side surface S14. A filter E8 is further provided between the seventh lens E7 and the image plane S17, and the filter E8 has an object side surface S15 and an image side surface S16. Light from the object sequentially passes through the surfaces S1 to S16 and is finally imaged on the image plane S17.

The spacing element group includes a second spacing element P2, a third spacing element P3, a fourth spacing element P4 and a fifth spacing element P5 disposed in the second lens barrel P02. Each of the spacing elements can block excess light in an imaging process from entering the next lens, while making the respective lenses and the second lens barrel P02 better supported, thereby enhancing the structural stability of the optical imaging lens assembly.

Table 4 shows a table of basic parameters of the optical imaging lens assembly of Embodiment 4, wherein the units of the radius of curvature, thickness/distance, and focal length are all millimeters (mm).

TABLE 4

| Surface | Surface | Radius of | | | | Focal | Cone |
|---|---|---|---|---|---|---|---|
| No. | type | curvature | Thickness | Material | | length | coefficient |
| OBJ | Spherical | Infinite | U | | | | |
| S1 | Aspherical | 6.3616 | 0.5000 | 1.64 | 23.5 | 214.59 | 0.4826 |
| S2 | Aspherical | 6.4633 | D1 | | | | 0.5923 |
| STO | Spherical | Infinite | −0.3722 | | | | 0.0000 |
| S3 | Aspherical | 4.0297 | 1.1334 | 1.55 | 55.9 | 7.83 | 0.0395 |
| S4 | Aspherical | 63.1879 | 0.0400 | | | | −99.0000 |
| S5 | Aspherical | 8.2757 | 0.3800 | 1.68 | 19.2 | −22.11 | 0.4900 |
| S6 | Aspherical | 5.2303 | 0.9685 | | | | 0.8405 |
| S7 | Aspherical | 35.6119 | 0.4900 | 1.68 | 19.2 | −21.55 | −99.0000 |
| S8 | Aspherical | 10.2915 | 0.1552 | | | | −44.2832 |
| S9 | Aspherical | 13.7730 | 0.9828 | 1.57 | 37.4 | 35.89 | −49.3158 |
| S10 | Aspherical | 41.0778 | 0.8146 | | | | 99.0000 |
| S11 | Aspherical | 4.6621 | 0.9629 | 1.55 | 55.9 | 9.58 | −0.8868 |
| S12 | Aspherical | 40.0082 | D2 | | | | 22.0817 |
| S13 | Aspherical | −45.5558 | 1.0434 | 1.55 | 55.9 | −6.54 | −99.0000 |
| S14 | Aspherical | 3.9063 | 0.4979 | | | | −0.9644 |
| S15 | Spherical | Infinite | 0.2100 | 1.52 | 64.2 | | |
| S16 | Spherical | Infinite | 0.4397 | | | | |
| S17 | Spherical | Infinite | | | | | |

In this embodiment, both the object side surface and image side surface of any one of the first lens E1 to the seventh lens E7 are aspherical. Table 5 shows high-order coefficients A₄, A₆, A₈, A₁₀, A₁₂, A₁₄, A₁₆, A₁₈, A₂₀, A₂₂, A₂₄, A₂₆, A₂₈ and A₃₀ of each of the aspherical surfaces S1 to S14 that are applicable in Embodiment 4.

TABLE 5

| Surface No. | A4 | A6 | A8 | A10 | A12 | A14 | A16 |
|---|---|---|---|---|---|---|---|
| S1 | −3.3894E−03 | 2.5770E−04 | −2.7962E−04 | 1.2360E−04 | −3.4380E−05 | 5.9784E−06 | −6.2702E−07 |
| S2 | −3.1466E−03 | 1.4110E−04 | −3.0542E−04 | 1.7472E−04 | −6.1178E−05 | 1.3151E−05 | −1.6823E−06 |
| S3 | 1.4078E−03 | 3.2363E−04 | −1.4625E−04 | 8.4555E−06 | 3.1109E−05 | −1.5460E−05 | 3.3611E−06 |
| S4 | −8.0620E−03 | 8.7931E−03 | −5.1845E−03 | 1.8686E−03 | −4.0139E−04 | 4.7446E−05 | −2.3476E−06 |
| S5 | −1.2737E−02 | 8.4356E−03 | −3.8145E−03 | 5.2969E−04 | 4.3412E−04 | −2.9171E−04 | 8.6624E−05 |
| S6 | −5.6327E−03 | 1.8047E−03 | −7.2409E−04 | 7.1930E−04 | −6.3275E−04 | 3.4199E−04 | −1.0899E−04 |
| S7 | −8.0574E−03 | 4.6609E−03 | −4.0876E−03 | 1.5839E−03 | −2.3961E−04 | −5.8929E−05 | 3.7471E−05 |
| S8 | −3.3362E−02 | 3.7358E−02 | −3.3861E−02 | 2.2887E−02 | −1.1520E−02 | 4.2473E−03 | −1.1336E−03 |
| S9 | −5.0353E−02 | 3.5606E−02 | −2.1852E−02 | 1.0316E−02 | −3.4700E−03 | 7.8198E−04 | −1.0782E−04 |
| S10 | −3.2334E−02 | 7.5806E−03 | −7.2345E−04 | −8.1169E−04 | 5.7483E−04 | −1.9904E−04 | 4.2865E−05 |
| S11 | −1.2303E−02 | 1.7956E−03 | −2.5083E−04 | −1.5587E−05 | 2.3656E−05 | −8.2464E−06 | 1.7169E−06 |
| S12 | 1.2176E−03 | 1.8867E−04 | −3.3373E−04 | 1.4744E−04 | −3.9134E−05 | 6.8789E−06 | −8.4172E−07 |
| S13 | −2.5607E−02 | 3.4503E−03 | −3.9473E−04 | 4.1465E−05 | −3.2824E−06 | 1.8294E−07 | −7.2284E−09 |
| S14 | −2.4749E−02 | 3.8449E−03 | −5.3926E−04 | 6.3117E−05 | −5.9676E−06 | 4.4043E−07 | −2.4698E−08 |

| Surface No. | A18 | A20 | A22 | A24 | A26 | A28 | A30 |
|---|---|---|---|---|---|---|---|
| S1 | 3.6184E−08 | −8.8110E−10 | 0.0000E+00 | 0.0000E+00 | 0.0000E+00 | 0.0000E+00 | 0.0000E+00 |
| S2 | 1.1726E−07 | −3.4236E−09 | 0.0000E+00 | 0.0000E+00 | 0.0000E+00 | 0.0000E+00 | 0.0000E+00 |
| S3 | −3.5563E−07 | 1.5271E−08 | 0.0000E+00 | 0.0000E+00 | 0.0000E+00 | 0.0000E+00 | 0.0000E+00 |
| S4 | 0.0000E+00 | 0.0000E+00 | 0.0000E+00 | 0.0000E+00 | 0.0000E+00 | 0.0000E+00 | 0.0000E+00 |
| S5 | −1.4544E−05 | 1.3503E−06 | −5.4724E−08 | 0.0000E+00 | 0.0000E+00 | 0.0000E+00 | 0.0000E+00 |
| S6 | 2.0171E−05 | −1.9947E−06 | 8.0661E−08 | 0.0000E+00 | 0.0000E+00 | 0.0000E+00 | 0.0000E+00 |
| S7 | −8.3279E−06 | 9.3182E−07 | −4.3505E−08 | 0.0000E+00 | 0.0000E+00 | 0.0000E+00 | 0.0000E+00 |
| S8 | 2.1559E−04 | −2.8383E−05 | 2.4503E−06 | −1.2442E−07 | 2.8092E−09 | 0.0000E+00 | 0.0000E+00 |
| S9 | 6.9485E−06 | 2.2692E−07 | −7.5006E−08 | 5.0885E−09 | −1.2175E−10 | 0.0000E+00 | 0.0000E+00 |
| S10 | −6.0022E−06 | 5.4515E−07 | −3.0962E−08 | 9.9957E−10 | −1.4011E−11 | 0.0000E+00 | 0.0000E+00 |
| S11 | −2.3864E−07 | 2.2835E−08 | −1.5077E−09 | 6.7386E−11 | −1.9443E−12 | 3.2650E−14 | −2.4219E−16 |
| S12 | 7.3355E−08 | −4.5787E−09 | 2.0302E−10 | −6.2383E−12 | 1.2624E−13 | −1.5123E−15 | 8.1227E−18 |
| S13 | 2.0912E−10 | −4.6767E−12 | 8.6597E−14 | −1.3588E−15 | 1.6548E−17 | −1.2989E−19 | 4.6913E−22 |
| S14 | 1.0330E−09 | −3.1725E−11 | 7.0154E−13 | −1.0829E−14 | 1.1048E−16 | −6.6817E−19 | 1.8121E−21 |

In this embodiment, the total effective focal length f of the optical imaging lens assembly is 8.35 mm.

Table 6 shows the distance U between the captured object and the optical imaging lens assembly, the air spacing D1 between the first lens group and the second lens group on the optical axis, and the air spacing D2 between the second lens group and the third lens group on the optical axis according to Embodiment 4, wherein the units of U, D1, and D2 are all millimeters (mm). When U is infinite, the optical imaging lens assembly is in a telephoto state; when U is 150 mm, the optical imaging lens assembly is in a short focal length state.

TABLE 6

| | | |
|---|---|---|
| Object distance U | Infinity | 150 |
| D1 | 0.9464 | 0.6276 |
| D2 | 1.8073 | 2.1261 |

### Embodiment 5

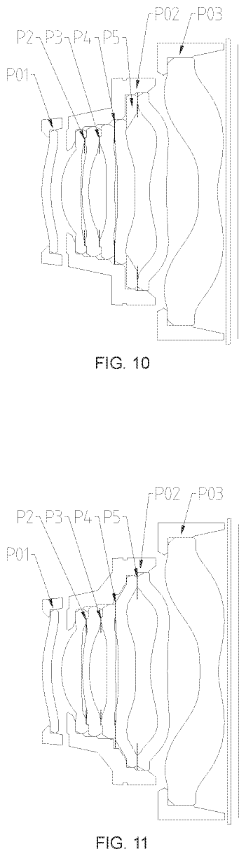

An optical imaging lens assembly according to Embodiment 5 of the present application will be described below with reference to FIGS. 8 and 10.

As shown in FIGS. 8 and 10, the optical imaging lens assembly includes a lens barrel subassembly, an optical lens group and a spacing element group. The lens barrel subassembly includes a first lens barrel P01, a second lens barrel P02 and a third lens barrel P03 arranged in order from an object side to an image plane along an optical axis. The structure of the optical lens group is the same as that of the optical lens group of Embodiment 4. The spacing element group includes a second spacing element P2, a third spacing element P3, a fourth spacing element P4 and a fifth spacing element P5 disposed in the second lens barrel P02.

The structure of the optical lens group of this embodiment is the same as that of the optical lens group of Embodiment 4, that is, the basic parameter table of the optical imaging lens assembly of this embodiment is the same as Table 4, and the aspheric coefficient table is the same as Table 5. The difference between this embodiment and Embodiment 4 is that the structural dimensions of the first lens barrel P01, the second lens barrel P02, the third lens barrel P03, the second spacing element P2, the third spacing element P3, the fourth spacing element P4 and the fifth spacing element P5 are different. For example, parameters such as L1, L2, L3, d02s, d02m, D02m, d03s, d4s, D4m, d5s, D5m, ΔEP0, EP022, EP23, EP34 and EP45 are different.

### Embodiment 6

An optical imaging lens assembly according to Embodiment 6 of the present application will be described below with reference to FIGS. 8 and 11.

As shown in FIGS. 8 and 11, the optical imaging lens assembly includes a lens barrel subassembly, an optical lens group and a spacing element group. The lens barrel subassembly includes a first lens barrel P01, a second lens barrel P02 and a third lens barrel P03 arranged in order from an object side to an image plane along an optical axis. The structure of the optical lens group is the same as that of the optical lens group of Embodiment 4. The spacing element group includes a second spacing element P2, a third spacing element P3, a fourth spacing element P4 and a fifth spacing element P5 disposed in the second lens barrel P02.

The structure of the optical lens group of this embodiment is the same as that of the optical lens group of Embodiment 4, that is, the basic parameter table of the optical imaging lens assembly of this embodiment is the same as Table 4, and the aspheric coefficient table is the same as Table 5. The difference between this embodiment and Embodiment 4 is that the structural dimensions of the first lens barrel P01, the second lens barrel P02, the third lens barrel P03, the second spacing element P2, the third spacing element P3, the fourth spacing element P4 and the fifth spacing element P5 are different. For example, parameters such as L1, L2, L3, d02s, d02m, D02m, d03s, d4s, D4m, d5s, D5m, ΔEP0, EP022, EP23, EP34 and EP45 are different.

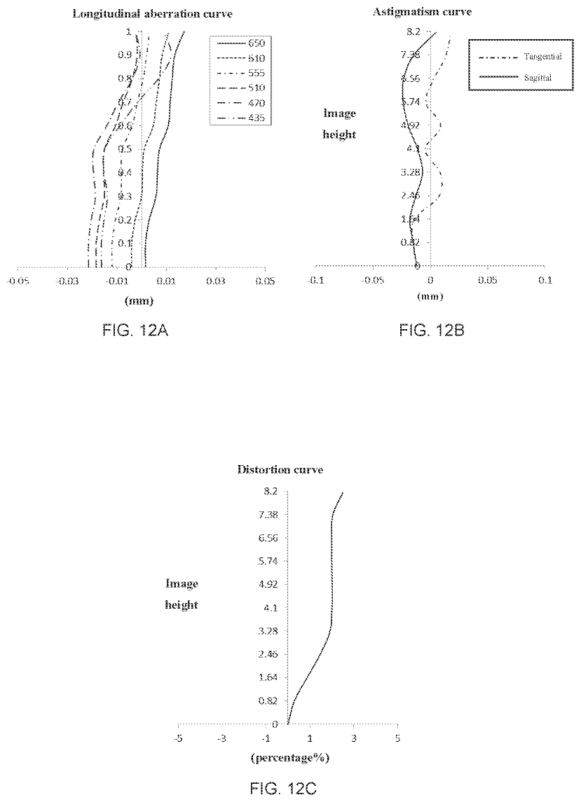

FIG. 12A shows a longitudinal aberration curve of the optical imaging lens assembly of Embodiment 4, 5 or 6 in the telephoto state, which indicates the deviation of the converged focal point of light of the respective different wavelengths after passing through the optical imaging lens assembly. FIG. 12B shows an astigmatism curve of the optical imaging lens assembly of Embodiment 4, 5 or 6 in the telephoto state, which indicates the curvature of the tangential image plane and the curvature of the sagittal image plane corresponding to different image heights. FIG. 12C shows a distortion curve of the optical imaging lens assembly of Embodiment 4, 5 or 6 in the telephoto state, which indicates distortion magnitude values corresponding to different image heights. It can be seen from FIGS. 12A to 12C that the optical imaging lens assembly of Embodiment 4, 5 or 6 can achieve good imaging quality in the telephoto state.

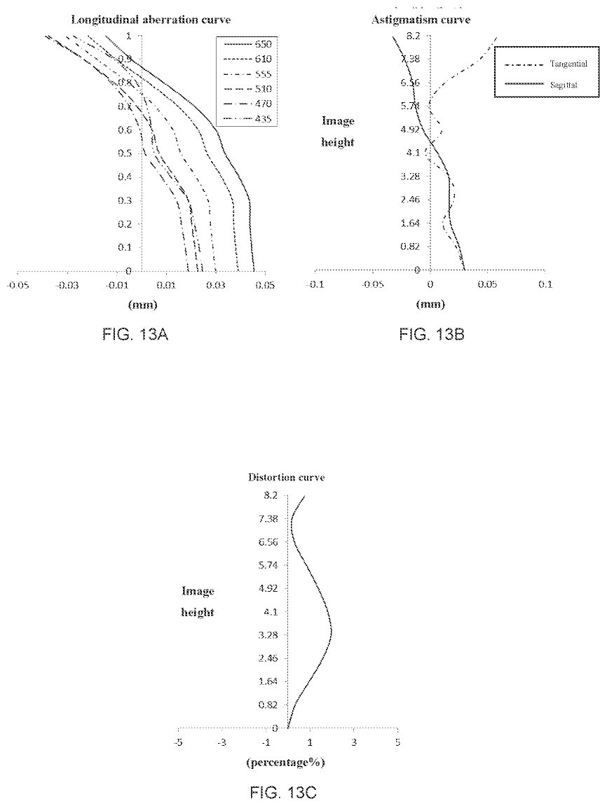

FIG. 13A shows a longitudinal aberration curve of the optical imaging lens assembly of Embodiment 4, 5 or 6 in the short focal length state, which indicates the deviation of the converged focal point of light of the respective different wavelengths after passing through the optical imaging lens assembly. FIG. 13B shows an astigmatism curve of the optical imaging lens assembly of Embodiment 4, 5 or 6 in the short focal length state, which indicates the curvature of the tangential image plane and the curvature of the sagittal image plane corresponding to different image heights. FIG. 13C shows a distortion curve of the optical imaging lens assembly of Embodiment 4, 5 or 6 in the short focal length state, which indicates distortion magnitude values corresponding to different image heights. It can be seen from FIGS. 13A to 13C that the optical imaging lens assembly of Embodiment 4, 5 or 6 can achieve good imaging quality in the short focal length state.

### Embodiment 7

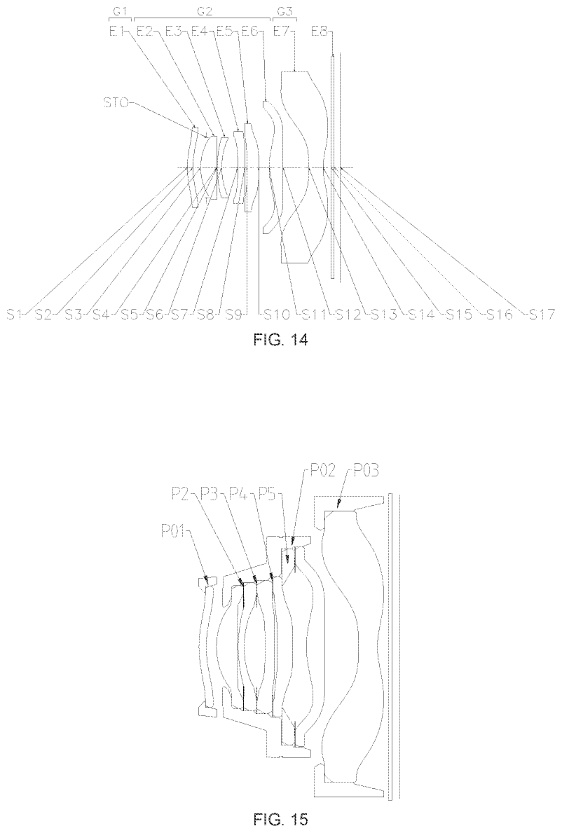

An optical imaging lens assembly according to Embodiment 7 of the present application will be described below with reference to FIGS. 14 and 15.

As shown in FIGS. 14 and 15, the optical imaging lens assembly includes a lens barrel subassembly, an optical lens group and a spacing element group. The lens barrel subassembly includes a first lens barrel P01, a second lens barrel P02 and a third lens barrel P03 arranged in order from an object side to an image plane along an optical axis.

The optical lens group includes, in order from the object side to the image plane along the optical axis: a first lens group G1 disposed in the first lens barrel P01, a second lens group G2 disposed in the second lens barrel P02 and having a positive refractive power, and a third lens group G3 disposed in the third lens barrel P03 and having a negative refractive power. The positions of the first lens group G1 and the third lens group G3 relative to the image plane on the optical axis are fixed. The second lens group G2 is movable relative to the first lens group G1 along the optical axis. When the distance between a captured object and the optical imaging lens assembly changes from far to near, the distance between the second lens group G2 and the first lens group G1 on the optical axis is adjusted, so that the optical imaging lens assembly can be switched between a telephoto state and a short focal length state, thereby achieving the zoom of the optical imaging lens assembly. In an example, the first lens group G1 includes a first lens E1. The second lens group G2 includes a second lens E2, a third lens E3, a fourth lens E4, a fifth lens E5, and a sixth lens E6 in order from the object side to the image plane along the optical axis. The third lens group G3 includes a seventh lens E7. The second lens group G2 further includes a diaphragm STO, which is disposed between the object side and the second lens E2.

The first lens E1 has a negative refractive power, and has a convex object side surface S1 and a concave image side surface S2. The second lens E2 has a positive refractive power, and has a convex object side surface S3 and a convex image side surface S4. The third lens E3 has a negative refractive power, and has a convex object side surface S5 and a concave image side surface S6. The fourth lens E4 has a negative focal power, and has a concave object side surface S7 and a concave image side surface S8. The fifth lens E5 has a positive refractive power, and has a convex object side surface S9 and a concave image side surface S10. The sixth lens E6 has a positive refractive power, and has a convex object side surface S11 and a convex image side surface S12. The seventh lens E7 has a negative refractive power, and has a concave object side surface S13 and a concave image side surface S14. A filter E8 is further provided between the seventh lens E7 and the image plane S17, and the filter E8 has an object side surface S15 and an image side surface S16. Light from the object sequentially passes through the surfaces S1 to S16 and is finally imaged on the image plane S17.

The spacing element group includes a second spacing element P2, a third spacing element P3, a fourth spacing element P4 and a fifth spacing element P5 disposed in the second lens barrel P02. Each of the spacing elements can block excess light in an imaging process from entering the next lens, while making the respective lenses and the second lens barrel P02 better supported, thereby enhancing the structural stability of the optical imaging lens assembly.

Table 7 shows a table of basic parameters of the optical imaging lens assembly of Embodiment 7, wherein the units of the radius of curvature, thickness/distance, and focal length are all millimeters (mm).

TABLE 7

| Surface | Surface | Radius of | | | | Focal | Cone |
|---|---|---|---|---|---|---|---|
| No. | type | curvature | Thickness | Material | | length | coefficient |
| OBJ | Spherical | Infinite | U | | | | |
| S1 | Aspherical | 6.3669 | 0.4070 | 1.64 | 23.5 | −411.98 | −0.0634 |
| S2 | Aspherical | 6.0620 | D1 | | | | 0.0015 |
| STO | Spherical | Infinite | −0.4246 | | | | 0.0000 |
| S3 | Aspherical | 4.1847 | 1.1731 | 1.55 | 55.9 | 7.45 | 0.0091 |
| S4 | Aspherical | −129.7655 | 0.0400 | | | | −99.0000 |
| S5 | Aspherical | 6.8901 | 0.3300 | 1.68 | 19.2 | −23.33 | 0.2211 |
| S6 | Aspherical | 4.7044 | 1.1694 | | | | 0.0260 |
| S7 | Aspherical | −59.9381 | 0.5189 | 1.68 | 19.2 | −30.42 | 67.3830 |
| S8 | Aspherical | 31.4753 | 0.1608 | | | | 22.2973 |
| S9 | Aspherical | 35.1319 | 0.8611 | 1.57 | 37.4 | 342.92 | 85.1226 |
| S10 | Aspherical | 42.4506 | 0.7641 | | | | −2.6841 |
| S11 | Aspherical | 5.2634 | 1.0170 | 1.55 | 55.9 | 8.83 | −0.6497 |
| S12 | Aspherical | −52.9742 | D2 | | | | −99.0000 |
| S13 | Aspherical | −33.9617 | 1.0553 | 1.55 | 55.9 | −6.59 | −99.0000 |
| S14 | Aspherical | 4.0628 | 0.6080 | | | | −0.9580 |
| S15 | Spherical | Infinite | 0.2100 | 1.52 | 64.2 | | |
| S16 | Spherical | Infinite | 0.4411 | | | | |
| S17 | Spherical | Infinite | | | | | |

In this embodiment, both the object side surface and image side surface of any one of the first lens E1 to the seventh lens E7 are aspherical. Table 8 shows high-order coefficients A₄, A₆, A₈, A₁₀, A₁₂, A₁₄, A₁₆, A₁₈, A₂₀, A₂₂, A₂₄, A₂₆, A₂₈ and A₃₀ of each of the aspherical surfaces S1 to S14 that are applicable in Embodiment 7.

TABLE 8

| Surface No. | A4 | A6 | A8 | A10 | A12 | A14 | A16 |
|---|---|---|---|---|---|---|---|
| S1 | −4.0986E−03 | −9.0180E−05 | −1.1792E−04 | 7.5334E−05 | −2.4660E−05 | 4.7946E−06 | −5.4591E−07 |
| S2 | −3.7852E−03 | −4.3857E−04 | 4.2444E−05 | 3.3296E−05 | −2.2239E−05 | 6.3559E−06 | −9.5880E−07 |
| S3 | 1.8893E−03 | −5.1684E−04 | 6.7108E−04 | 5.2534E−04 | 2.5716E−04 | −7.7492E−05 | 1.4007E−05 |
| S4 | 3.6666E−04 | 2.2809E−03 | −1.7677E−03 | 6.3751E−04 | −5.8578E−05 | −3.4479E−05 | 1.3175E−05 |
| S5 | −8.2280E−03 | 3.9690E−03 | −2.1735E−03 | 7.2219E−04 | −3.8114E−05 | −5.7595E−05 | 2.1334E−05 |
| S6 | −7.9911E−03 | 1.6536E−03 | 5.4285E−04 | −1.0434E−03 | 7.1415E−04 | −2.7036E−04 | 6.0510E−05 |
| S7 | −4.9712E−03 | −2.5460E−04 | 3.1231E−04 | −1.4224E−03 | 1.2674E−03 | −5.7289E−04 | 1.5147E−04 |
| S8 | −1.3004E−02 | 1.0000E−02 | −8.7937E−03 | 5.7028E−03 | −2.8528E−03 | 1.0651E−03 | −2.8688E−04 |
| S9 | −2.6751E−02 | 1.3212E−02 | −7.0085E−03 | 3.3391E−03 | −1.3027E−03 | 3.8050E−04 | −7.8128E−05 |
| S10 | −2.6589E−02 | 4.6863E−03 | −5.9693E−04 | −7.7625E−05 | 6.6452E−05 | −1.5674E−05 | 1.4254E−06 |
| S11 | −6.3259E−03 | −8.6966E−04 | 6.9024E−04 | −2.7015E−04 | 7.0860E−05 | −1.3620E−05 | 1.9615E−06 |
| S12 | 6.0551E−03 | −1.7197E−03 | 3.9849E−04 | −7.2914E−05 | 7.5017E−06 | −1.3037E−07 | −7.6113E−08 |
| S13 | −1.9447E−02 | 8.5058E−04 | 2.8221E−04 | −7.2245E−05 | 9.3428E−06 | −7.8541E−07 | 4.5895E−08 |
| S14 | −1.8141E−02 | 1.3584E−03 | 5.3999E−06 | −1.6172E−05 | 2.1801E−06 | −1.6649E−07 | 8.4782E−09 |
| Surface No. | A18 | A20 | A22 | A24 | A26 | A28 | A30 |
| S1 | 3.3528E−08 | −8.5663E−10 | 0.0000E+00 | 0.0000E+00 | 0.0000E+00 | 0.0000E+00 | 0.0000E+00 |
| S2 | 7.4261E−08 | −2.3275E−09 | 0.0000E+00 | 0.0000E+00 | 0.0000E+00 | 0.0000E+00 | 0.0000E+00 |
| S3 | −1.3887E−06 | 5.8085E−08 | 0.0000E+00 | 0.0000E+00 | 0.0000E+00 | 0.0000E+00 | 0.0000E+00 |
| S4 | −1.8489E−06 | 9.5950E−08 | 0.0000E+00 | 0.0000E+00 | 0.0000E+00 | 0.0000E+00 | 0.0000E+00 |
| S5 | −3.3433E−06 | 2.3834E−07 | −5.7504E−09 | 0.0000E+00 | 0.0000E+00 | 0.0000E+00 | 0.0000E+00 |
| S6 | −7.7492E−06 | 5.0440E−07 | −1.1979E−08 | 0.0000E+00 | 0.0000E+00 | 0.0000E+00 | 0.0000E+00 |
| S7 | −2.3795E−05 | 2.0739E−06 | −7.7616E−08 | 0.0000E+00 | 0.0000E+00 | 0.0000E+00 | 0.0000E+00 |
| S8 | 5.4438E−05 | −7.0678E−06 | 5.9599E−07 | −2.9342E−08 | 6.3876E−10 | 0.0000E+00 | 0.0000E+00 |
| S9 | 1.0998E−05 | −1.0431E−06 | 6.4210E−08 | −2.3391E−09 | 3.8632E−11 | 0.0000E+00 | 0.0000E+00 |
| S10 | 1.2196E−07 | −4.5546E−08 | 4.8586E−09 | −2.4047E−10 | 4.6907E−12 | 0.0000E+00 | 0.0000E+00 |
| S11 | −2.1132E−07 | 1.6807E−08 | −9.6521E−10 | 3.8681E−11 | −1.0214E−12 | 1.5916E−14 | −1.1061E−16 |
| S12 | 1.1907E−08 | −9.6131E−10 | 4.8975E−11 | −1.6298E−12 | 3.4506E−14 | −4.2295E−16 | 2.2866E−18 |
| S13 | −1.9176E−09 | 5.7824E−11 | −1.2506E−12 | 1.8942E−14 | −1.9089E−16 | 1.1502E−18 | −3.1359E−21 |
| S14 | −3.0246E−10 | 7.6725E−12 | −1.3779E−13 | 1.7122E−15 | −1.4002E−17 | 6.7835E−20 | −1.4767E−22 |

In this embodiment, the total effective focal length f of the optical imaging lens assembly is 8.52 mm.

Table 9 shows the distance U between the captured object and the optical imaging lens assembly, the air spacing D1 between the first lens group and the second lens group on the optical axis, and the air spacing D2 between the second lens group and the third lens group on the optical axis according to Embodiment 7, wherein the units of U, D1, and D2 are all millimeters (mm). When U is infinite, the optical imaging lens assembly is in a telephoto state; when U is 150 mm, the optical imaging lens assembly is in a short focal length state.

TABLE 9

| | | |
|---|---|---|
| Object distance U | Infinity | 150 |
| D1 | 0.9924 | 0.6636 |
| D2 | 1.8914 | 2.2202 |

### Embodiment 8

An optical imaging lens assembly according to Embodiment 8 of the present application will be described below with reference to FIGS. 14 and 16.

As shown in FIGS. 14 and 16, the optical imaging lens assembly includes a lens barrel subassembly, an optical lens group and a spacing element group. The lens barrel subassembly includes a first lens barrel P01, a second lens barrel P02 and a third lens barrel P03 arranged in order from an object side to an image plane along an optical axis. The structure of the optical lens group is the same as that of the optical lens group of Embodiment 7. The spacing element group includes a second spacing element P2, a third spacing element P3, a fourth spacing element P4 and a fifth spacing element P5 disposed in the second lens barrel P02.

The structure of the optical lens group of this embodiment is the same as that of the optical lens group of Embodiment 7, that is, the basic parameter table of the optical imaging lens assembly of this embodiment is the same as Table 7, and the aspheric coefficient table is the same as Table 8. The difference between this embodiment and Embodiment 7 is that the structural dimensions of the first lens barrel P01, the second lens barrel P02, the third lens barrel P03, the second spacing element P2, the third spacing element P3, the fourth spacing element P4 and the fifth spacing element P5 are different. For example, parameters such as L1, L2, L3, d02s, d02m, D02m, d03s, d4s, D4m, d5s, D5m, ΔEP0, EP022, EP23, EP34 and EP45 are different.

### Embodiment 9

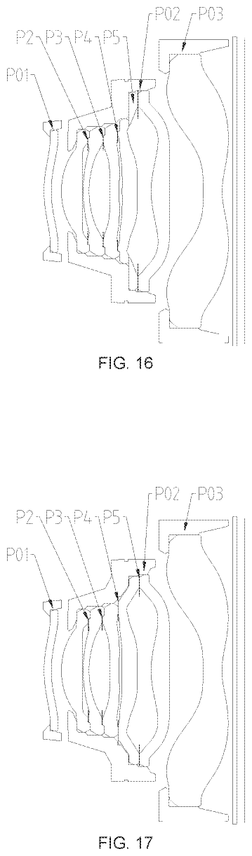

An optical imaging lens assembly according to Embodiment 9 of the present application will be described below with reference to FIGS. 14 and 17.

As shown in FIGS. 14 and 17, the optical imaging lens assembly includes a lens barrel subassembly, an optical lens group and a spacing element group. The lens barrel subassembly includes a first lens barrel P01, a second lens barrel P02 and a third lens barrel P03 arranged in order from an object side to an image plane along an optical axis. The structure of the optical lens group is the same as that of the optical lens group of Embodiment 7. The spacing element group includes a second spacing element P2, a third spacing element P3, a fourth spacing element P4 and a fifth spacing element P5 disposed in the second lens barrel P02.

The structure of the optical lens group of this embodiment is the same as that of the optical lens group of Embodiment 7, that is, the basic parameter table of the optical imaging lens assembly of this embodiment is the same as Table 7, and the aspheric coefficient table is the same as Table 8. The difference between this embodiment and Embodiment 7 is that the structural dimensions of the first lens barrel P01, the second lens barrel P02, the third lens barrel P03, the second spacing element P2, the third spacing element P3, the fourth spacing element P4 and the fifth spacing element P5 are different. For example, parameters such as L1, L2, L3, d02s, d02m, D02m, d03s, d4s, D4m, d5s, D5m, ΔEP0, EP022, EP23, EP34 and EP45 are different.

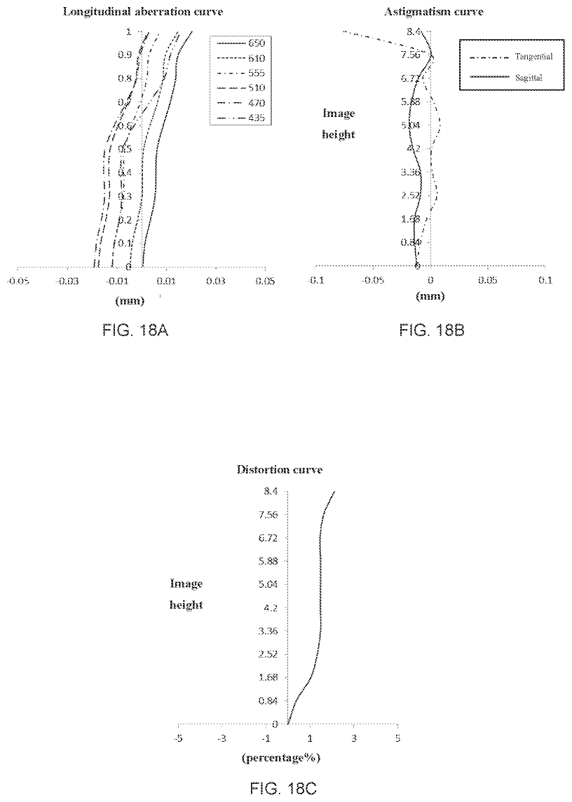

FIG. 18A shows a longitudinal aberration curve of the optical imaging lens assembly of Embodiment 7, 8 or 9 in the telephoto state, which indicates the deviation of the converged focal point of light of the respective different wavelengths after passing through the optical imaging lens assembly. FIG. 18B shows an astigmatism curve of the optical imaging lens assembly of Embodiment 7, 8 or 9 in the telephoto state, which indicates the curvature of the tangential image plane and the curvature of the sagittal image plane corresponding to different image heights. FIG. 18C shows a distortion curve of the optical imaging lens assembly of Embodiment 7, 8 or 9 in the telephoto state, which indicates distortion magnitude values corresponding to different image heights. It can be seen from FIGS. 18A to 18C that the optical imaging lens assembly of Embodiment 7, 8 or 9 can achieve good imaging quality in the telephoto state.

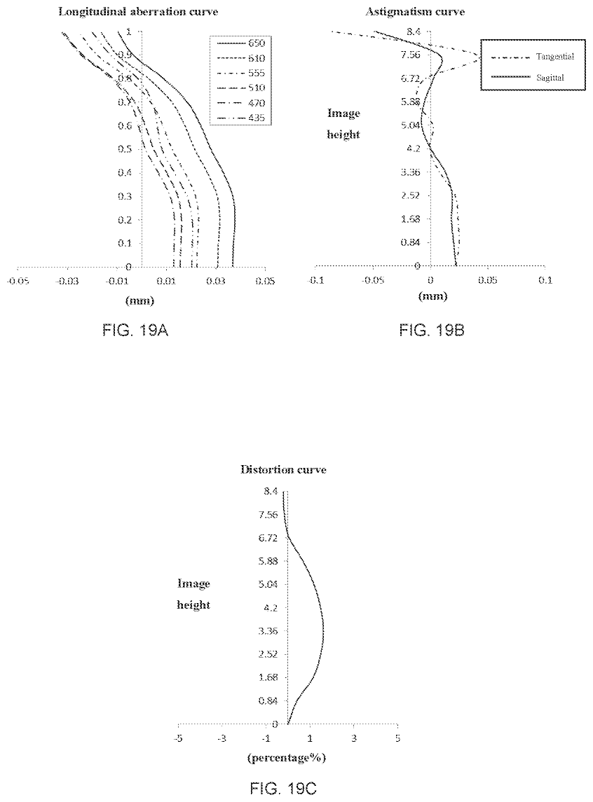

FIG. 19A shows a longitudinal aberration curve of the optical imaging lens assembly of Embodiment 7, 8 or 9 in the short focal length state, which indicates the deviation of the converged focal point of light of the respective different wavelengths after passing through the optical imaging lens assembly. FIG. 19B shows an astigmatism curve of the optical imaging lens assembly of Embodiment 7, 8 or 9 in the short focal length state, which indicates the curvature of the tangential image plane and the curvature of the sagittal image plane corresponding to different image heights. FIG. 19C shows a distortion curve of the optical imaging lens assembly of Embodiment 7, 8 or 9 in the short focal length state, which indicates distortion magnitude values corresponding to different image heights. It can be seen from FIGS. 19A to 19C that the optical imaging lens assembly of Embodiment 7, 8 or 9 can achieve good imaging quality in the short focal length state.

Table 10 shows the values of parameters such as L1, L2, L3, d02s, d02m, D02m, d03s, d4s, D4m, d5s, D5m, ΔEP0, EP022, EP23, EP34, EP45 and F2 of each of Embodiments 1 to 9. Some of the above parameters can be measured according to the labeling method shown in FIG. 1, and the units of the parameters listed in Table 10 are all mm.

TABLE 10

| | Embodiment | | | | | | | | |
|---|---|---|---|---|---|---|---|---|---|
| Parameter | 1 | 2 | 3 | 4 | 5 | 6 | 7 | 8 | 9 |
| d02s | 5.0177 | 5.0177 | 5.0177 | 4.7738 | 4.7738 | 4.7738 | 4.5916 | 4.5916 | 4.5916 |
| d02m | 12.1234 | 12.1234 | 12.1234 | 11.9234 | 11.9234 | 11.9234 | 11.6234 | 11.6234 | 11.6234 |
| D02m | 12.96 | 12.96 | 12.96 | 12.7313 | 12.7313 | 12.7313 | 12.4313 | 12.4313 | 12.4313 |
| d03s | 14.0183 | 14.0183 | 14.0183 | 13.5183 | 13.5183 | 13.5183 | 13.5183 | 13.5183 | 13.5183 |
| d4s | 5.1176 | 5.3916 | 6.2597 | 5.3544 | 5.4687 | 5.4687 | 5.4372 | 5.4372 | 5.5424 |
| D4m | 8.1 | 8.3 | 9.1669 | 7.9114 | 8.1673 | 8.6941 | 7.9114 | 6.6573 | 8.336 |
| d5s | 7.9478 | 7.9478 | 8.6392 | 6.9026 | 7.1585 | 8.1322 | 6.9394 | 7.4003 | 8.3252 |
| D5m | 10.8244 | 11.1317 | 11.5376 | 10.8244 | 10.6123 | 11.1376 | 10.7268 | 10.7268 | 10.7508 |
| EP022 | 1.1404 | 1.1156 | 1.2033 | 1.0838 | 1.0264 | 1.0892 | 1.1552 | 1.1145 | 1.152 |
| EP23 | 0.7281 | 0.7786 | 0.8129 | 0.7281 | 0.8034 | 0.8021 | 0.7322 | 0.8404 | 0.7529 |
| EP34 | 0.7197 | 0.794 | 0.9872 | 0.8424 | 0.8506 | 0.7892 | 0.8632 | 0.7957 | 0.8764 |
| EP45 | 1.1035 | 1.0035 | 1.1427 | 0.6277 | 0.6476 | 1.2046 | 0.493 | 0.6165 | 1.1692 |
| L1 | 1.0311 | 1.0311 | 1.0311 | 1.1301 | 1.1301 | 1.1301 | 1.0226 | 1.0226 | 1.0226 |
| L2 | 5.2896 | 5.2896 | 5.2896 | 4.8595 | 4.8595 | 4.8595 | 4.8595 | 4.8595 | 4.8595 |
| L3 | 3.672 | 3.672 | 3.672 | 3.7325 | 3.7325 | 3.7325 | 3.8832 | 3.8832 | 3.8832 |
| ΔEP0 | 0.384 | 0.384 | 0.384 | 0.3188 | 0.3188 | 0.3188 | 0.3288 | 0.3288 | 0.3288 |
| F2 | 7.0303 | 7.0303 | 7.0303 | 7.0598 | 7.0598 | 7.0598 | 6.9146 | 6.9146 | 6.9146 |

Table 11 shows the values of conditional expressions of each of Embodiments 1-9.

TABLE 11

| Conditional | Embodiment | | | | | | | | |
|---|---|---|---|---|---|---|---|---|---|
| Expression | 1 | 2 | 3 | 4 | 5 | 6 | 7 | 8 | 9 |
| f45/F2 | −4.96 | −4.96 | −4.96 | −7.50 | −7.50 | −7.50 | −4.79 | −4.79 | −4.79 |
| (CT5 + T56)/EP45 | 1.20 | 1.32 | 1.16 | 2.86 | 2.78 | 1.49 | 3.30 | 2.64 | 1.39 |
| EP34/(CT4 + T45) | 0.62 | 0.69 | 0.85 | 1.31 | 1.32 | 1.22 | 1.27 | 1.17 | 1.29 |
| d4s/(N4 × CT4) | 6.35 | 6.69 | 7.77 | 6.52 | 6.66 | 6.66 | 6.25 | 6.25 | 6.37 |
| d5s/(N5 × CT5) | 6.39 | 6.39 | 6.95 | 4.47 | 4.64 | 5.27 | 5.13 | 5.47 | 6.16 |
| f23/F2 | 1.38 | 1.38 | 1.38 | 1.56 | 1.56 | 1.56 | 1.45 | 1.45 | 1.45 |
| (T34 − EP23)/CT3 | 0.53 | 0.40 | 0.31 | 0.63 | 0.43 | 0.44 | 1.32 | 1.00 | 1.26 |
| (f2/N2)/EP022 | 3.98 | 4.07 | 3.77 | 4.68 | 4.94 | 4.65 | 4.17 | 4.33 | 4.18 |
| CT2/(EP022 − T23) | 1.24 | 1.27 | 1.17 | 1.09 | 1.15 | 1.08 | 1.05 | 1.09 | 1.05 |
| f6/(D5m − d5s) | 3.52 | 3.18 | 3.50 | 2.44 | 2.77 | 3.19 | 2.33 | 2.65 | 3.64 |
| f45/(D4m − d4s) | −11.69 | −11.99 | −11.99 | −20.70 | −19.61 | −16.41 | −13.39 | −27.16 | −11.86 |
| d02m/F2 | 1.72 | 1.72 | 1.72 | 1.69 | 1.69 | 1.69 | 1.68 | 1.68 | 1.68 |
| (D02m − d02s)/L2 | 1.50 | 1.50 | 1.50 | 1.64 | 1.64 | 1.64 | 1.61 | 1.61 | 1.61 |
| (d03s − D02m)/ΔEP0 | 2.76 | 2.76 | 2.76 | 2.47 | 2.47 | 2.47 | 3.31 | 3.31 | 3.31 |
| (L1 + L2 + L3)/ΔEP0 | 26.02 | 26.02 | 26.02 | 30.50 | 30.50 | 30.50 | 29.70 | 29.70 | 29.70 |

The present application further provides an imaging apparatus, of which an electronic photosensitive element may be a Charge-coupled Device (CCD) element or a Complementary Metal-Oxide Semiconductor (CMOS) element. The imaging apparatus may be an independent imaging apparatus such as a digital camera, or may be an imaging module integrated in a mobile electronic device such as a mobile phone. The imaging apparatus is equipped with the optical imaging lens assembly described above.

The above description is only the preferred embodiments of the present application and the explanation of the applied technical principle. It should be understood by those skilled in the art that the scope of disclosure involved in the present application is not limited to technical solutions formed by specific combinations of the above technical features, and at the same time, should also cover other technical solutions formed by any combination of the above technical features or equivalent features thereof without departing from the concept of the disclosure. For example, the above features and (but not limited to) the technical features with similar functions disclosed in the present application are replaced with each other to form technical solutions.

What is claimed is:

1. An optical imaging lens assembly, comprising a lens barrel subassembly, an optical lens group and a spacing element group, the lens barrel subassembly comprising a first lens barrel, a second lens barrel and a third lens barrel arranged in order from an object side to an image plane along an optical axis, wherein
the optical lens group comprises, in order from the object side to the image plane along the optical axis:
a first lens group disposed in the first lens barrel and comprising a first lens having a refractive power;
a second lens group disposed in the second lens barrel and having a positive refractive power, comprising a second lens having a positive refractive power, a third lens having a negative refractive power, a fourth lens having a negative refractive power, a fifth lens having a refractive power and a sixth lens having a positive refractive power; and
a third lens group disposed in the third lens barrel, comprising a seventh lens having a negative refractive power;
positions of the first lens group and the third lens group relative to the image plane on the optical axis are fixed, and a distance of the second lens group relative to the first lens group on the optical axis is adjustable;
the spacing element group comprises a fourth spacing element disposed on an image side surface of the fourth lens and being in contact with the image side surface of the fourth lens, and a fifth spacing element disposed on an image side surface of the fifth lens and being in contact with the image side surface of the fifth lens;
an effective focal length F2 of the second lens group and a combined focal length f45 of the fourth lens and the fifth lens satisfy: −7.50≤f45/F2≤−4.79; and
a center thickness CT5 of the fifth lens on the optical axis, an air spacing T56 between the fifth lens and the sixth lens on the optical axis and a spacing EP45 between the fourth spacing element and the fifth spacing element along the optical axis satisfy:
$$1.16 \leq ( CT 5 + T 56 ) / EP 45 \leq 3.30 .$$

2. The optical imaging lens assembly according to claim 1, wherein the spacing element group further comprises a third spacing element disposed on an image side surface of the third lens and being in contact with the image side surface of the third lens,
wherein a center thickness CT4 of the fourth lens on the optical axis, an air spacing T45 between the fourth lens and the fifth lens on the optical axis, and a spacing EP34 between the third spacing element and the fourth spacing element along the optical axis satisfy:
$$0.62 \leq EP 34 / ( CT 4 + T 45 ) \leq 1.32 .$$

3. The optical imaging lens assembly according to claim 1, wherein an inner diameter d4s of an object side surface of the fourth spacing element, a center thickness CT4 of the fourth lens on the optical axis and a refractive index N4 of the fourth lens satisfy:
$$6.25 \leq d 4 s / ( N 4 \times CT 4 ) \leq 7.77 .$$

4. The optical imaging lens assembly according to claim 1, wherein an inner diameter d5s of an object side surface of the fifth spacing element, the center thickness CT5 of the fifth lens on the optical axis and a refractive index N5 of the fifth lens satisfy:
$$4.47 \leq d 5 s / ( N 5 \times CT 5 ) \leq 6.95 .$$

5. The optical imaging lens assembly according to claim 1, wherein the spacing element group further comprises a second spacing element disposed on an image side surface of the second lens and being in contact with the image side surface of the second lens, and a third spacing element disposed on an image side surface of the third lens and being in contact with the image side surface of the third lens,
wherein the effective focal length F2 of the second lens group and a combined focal length f23 of the second lens and the third lens satisfy: 1.38≤f23/F2<1.6; and a center thickness CT3 of the third lens on the optical axis, an air spacing T34 between the third lens and the fourth lens on the optical axis and a spacing EP23 between the second spacing element and the third spacing element along the optical axis satisfy: 0.3<(T34−EP23)/CT3≤1.32.

6. The optical imaging lens assembly according to claim 1, wherein the spacing element group further comprises a second spacing element disposed on an image side surface of the second lens and being in contact with the image side surface of the second lens, wherein an effective focal length f2 of the second lens, a refractive index N2 of the second lens, and a spacing EP022 between an object side end surface of the second lens barrel and the second spacing element along the optical axis satisfy: 3.77≤(f2/N2)/EP022≤4.94.

7. The optical imaging lens assembly according to claim 1, wherein the spacing element group further comprises a second spacing element disposed on an image side surface of the second lens and being in contact with the image side surface of the second lens, wherein a center thickness CT2 of the second lens on the optical axis, an air spacing T23 between the second lens and the third lens on the optical axis, and a spacing EP022 between an object side end surface of the second lens barrel and the second spacing element along the optical axis satisfy: 1.05≤CT2/(EP022−T23)<1.3.

8. The optical imaging lens assembly according to claim 1, wherein an effective focal length f6 of the sixth lens, an inner diameter d5s of an object side surface of the fifth spacing element, and an outer diameter D5m of an image side surface of the fifth spacing element satisfy: 2.33≤f6/(D5m−d5s)≤3.64.

9. The optical imaging lens assembly according to claim 1, wherein the combined focal length f45 of the fourth lens and the fifth lens, an inner diameter d4s of an object side surface of the fourth spacing element and an outer diameter D4m of an image side surface of the fourth spacing element satisfy: −27.16≤f45/(D4m−d4s)≤−11.69.

10. The optical imaging lens assembly according to claim 1, wherein an inner diameter d02m of an image side end surface of the second lens barrel and the effective focal length F2 of the second lens group satisfy: 1.68≤d02m/F2≤1.72.

11. The optical imaging lens assembly according to claim 1, wherein an inner diameter d02s of an object side end surface of the second lens barrel, an outer diameter D02m of an image side end surface of the second lens barrel, and a length L2 of the second lens barrel along the direction of the optical axis satisfy: 1.50≤(D02m−d02s)/L2≤1.64.

12. The optical imaging lens assembly according to claim 1, wherein an outer diameter D02m of an image side end surface of the second lens barrel, an inner diameter d03s of an object side end surface of the third lens barrel and a maximum movable distance ΔEP0 of the second lens barrel along the direction of the optical axis satisfy: 2.47≤(d03s−D02m)/ΔEP0≤3.31.

13. The optical imaging lens assembly according to claim 1, wherein a length L1 of the first lens barrel along the direction of the optical axis, a length L2 of the second lens barrel along the direction of the optical axis, a length L3 of the third lens barrel along the direction of the optical axis and a maximum movable distance ΔEP0 of the second lens barrel along the direction of the optical axis satisfy: 26.02≤(L1+L2+L3)/ΔEP0≤30.50.

14. The optical imaging lens assembly according to claim 13, wherein the spacing element group further comprises a third spacing element disposed on an image side surface of the third lens and being in contact with the image side surface of the third lens,
wherein a center thickness CT4 of the fourth lens on the optical axis, an air spacing T45 between the fourth lens and the fifth lens on the optical axis, and a spacing EP34 between the third spacing element and the fourth spacing element along the optical axis satisfy:
$$0.62 \leq EP 34 / ( CT 4 + T 45 ) \leq 1.32 .$$

15. The optical imaging lens assembly according to claim 13, wherein an inner diameter d4s of an object side surface of the fourth spacing element, a center thickness CT4 of the fourth lens on the optical axis and a refractive index N4 of the fourth lens satisfy:
$$6.25 \leq d 4 s / ( N 4 \times CT 4 ) \leq 7.77 .$$

16. The optical imaging lens assembly according to claim 13, wherein an inner diameter d5s of an object side surface of the fifth spacing element, the center thickness CT5 of the fifth lens on the optical axis and a refractive index N5 of the fifth lens satisfy:
$$4.47 \leq d 5 s / ( N 5 \times CT 5 ) \leq 6.95 .$$

17. The optical imaging lens assembly according to claim 13, wherein the spacing element group further comprises a second spacing element disposed on an image side surface of the second lens and being in contact with the image side surface of the second lens, and a third spacing element disposed on an image side surface of the third lens and being in contact with the image side surface of the third lens,
wherein the effective focal length F2 of the second lens group and a combined focal length f23 of the second lens and the third lens satisfy: 1.38≤f23/F2<1.6; and a center thickness CT3 of the third lens on the optical axis, an air spacing T34 between the third lens and the fourth lens on the optical axis and a spacing EP23 between the second spacing element and the third spacing element along the optical axis satisfy: 0.3<(T34−EP23)/CT3≤1.32.

18. The optical imaging lens assembly according to claim 13, wherein the spacing element group further comprises a second spacing element disposed on an image side surface of the second lens and being in contact with the image side surface of the second lens,
wherein an effective focal length f2 of the second lens, a refractive index N2 of the second lens, and a spacing EP022 between an object side end surface of the second lens barrel and the second spacing element along the optical axis satisfy: 3.77≤(f2/N2)/EP022≤4.94.

19. The optical imaging lens assembly according to claim 13, wherein the spacing element group further comprises a second spacing element disposed on an image side surface of the second lens and being in contact with the image side surface of the second lens,
wherein a center thickness CT2 of the second lens on the optical axis, an air spacing T23 between the second lens and the third lens on the optical axis, and a spacing EP022 between an object side end surface of the second lens barrel and the second spacing element along the optical axis satisfy: 1.05≤CT2/(EP022−T23)<1.3.

20. The optical imaging lens assembly according to claim 13, wherein an effective focal length f6 of the sixth lens, an inner diameter d5s of an object side surface of the fifth spacing element, and an outer diameter D5m of an image side surface of the fifth spacing element satisfy: 2.33≤f6/(D5m−d5s)≤3.64.
